(19) United States
(12) Patent Application Publication
(10) Pub. No.: US 2023/0339765 A1
(43) Pub. Date: Oct. 26, 2023

(54) SOL-GEL PARTICLES INCLUDING HOMOGENEOUSLY DISPERSED DOPANTS AND RELATED METHODS AND SYSTEMS

(71) Applicant: Battelle Energy Alliance, LLC, Idaho Falls, ID (US)

(72) Inventors: Mathew S. Snow, Idaho Falls, ID (US); Kevin P. Carney, Idaho Falls, ID (US); Robert T. Lusk, Idaho Falls, ID (US); Justin T. Cooper, Idaho Falls, ID (US); Jacob Brookhart, Idaho Falls, ID (US)

(21) Appl. No.: 18/305,012

(22) Filed: Apr. 21, 2023

Related U.S. Application Data
(60) Provisional application No. 63/363,355, filed on Apr. 21, 2022.

(51) Int. Cl. C01B 33/142

(52) U.S. Cl. CPC C01B 33/142; C01P 2004/60; C01P 2006/88; C01P 2004/32

(57) ABSTRACT

Sol-gel particles comprising a reaction product of a sol-gel precursor, the reaction product comprising networked polymeric chains including silicon or a metal and at least one dopant substantially homogeneously dispersed in the reaction product of the sol-gel precursor. A method and system for producing the sol-gel particles are also disclosed.

### CROSS-REFERENCE TO RELATED APPLICATION

This application claims the benefit under 35 U.S.C. § 119(e) of U.S. Provisional Patent Application Ser. No. 63/363,355, filed Apr. 21, 2022, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to sol-gel particles including one or more dopants and advanced manufacturing systems and methods for producing the sol-gel particles including one or more dopants, such as radionuclides (e.g., radioisotopes), one or more stable (e.g., non-radioactive) chemical elements or chemical compounds, a combination of a radionuclide and a stable element, or a combination of radionuclides and stable chemical elements or chemical compounds. More particularly, the disclosure relates to sol-gel particles including one or more homogeneously distributed dopants and advanced manufacturing systems and methods for producing sol-gel particles including one or more homogeneously distributed dopants.

### BACKGROUND

Glass and ceramic based materials are of high interest to next generation science and engineering applications including nuclear and renewable energy, radiotherapy, and national security. Spherical radioactive and non-radioactive particles are useful in numerous fields including, but not limited to, nuclear surrogates for use in emergency response exercises and training, and controlled release of radioisotopes in nuclear medicine treatment regimens. Techniques that enable controlled synthesis of glass and ceramic based radioactive particles are needed.

### BRIEF SUMMARY

Sol-gel particles are disclosed and comprise a reaction product of a sol-gel precursor, wherein the reaction product comprises networked polymeric chains including silicon or a metal. The sol-gel particles include at least one dopant substantially homogeneously dispersed in the reaction product of the sol-gel precursor.

A method of producing sol-gel particles is disclosed and comprises forming a sol-gel precursor solution including at least one sol-gel precursor, at least one solvent, an acid, and at least one dopant. The method also includes dispensing the sol-gel precursor solution onto a print surface, and removing at least a portion of the at least one solvent from the sol-gel precursor solution on the print surface to form sol-gel particles including the at least one dopant substantially homogeneously dispersed throughout. The method further comprises removing the sol-gel particles from the print surface.

A system for producing sol-gel particles is also disclosed and comprises a print surface, and a transport assembly having a transport unit positionable over and along the print surface. A dispensing unit is coupled to the transport unit and is positionable with the transport unit over and along the print surface, wherein the dispensing unit is configured to dispense a sol-gel precursor solution on the print surface. A reservoir is disposed in fluid communication with the dispensing unit and is configured to contain the sol-gel precursor solution. A precursor solution transfer unit is disposed in fluid communication with the reservoir and the dispensing unit, and a control unit is connected in communication and operable with at least the transport assembly and the precursor solution transfer unit.

### BRIEF DESCRIPTION OF THE DRAWINGS

For a detailed understanding of embodiments of the disclosure, reference should be made to the following detailed description, taken in conjunction with the accompanying drawings and appendices, in which like elements have generally been designated with like numerals, and wherein:

FIG. 1 is a diagrammatic representation of a polymerization reaction of a sol-gel precursor in a sol-gel precursor solution to form sol-gel particles, in accordance with one or more embodiments of the disclosure.

FIG. 2 is a diagrammatic representation of a substantially spherical sol-gel particle comprising a homogenously distributed dopant, in accordance with one or more embodiments of the disclosure.

FIG. 3 is a diagrammatic representation of a sol-gel precursor solution dispensing unit, in accordance with one or more embodiments of the disclosure.

FIG. 4 is a diagrammatic representation of sol-gel precursor solution droplets dispensed onto a print surface, in accordance with one or more embodiments of the disclosure.

FIG. 5 is a diagrammatic representation of a batch sol-gel particle production system, in accordance with one or more embodiments of the disclosure.

FIG. 6 is a diagrammatic representation of a portion of a batch sol-gel particle production system having a removal tool, in accordance with one or more embodiments of the disclosure.

FIG. 7 is a diagrammatic representation of a continuous sol-gel particle production system, in accordance with one or more embodiments of the disclosure.

FIGS. 8A through 8C are diagrammatic representations of the formation of sol-gel particles comprising one or more homogenously distributed dopants from a continuous linear deposition of sol-gel precursor solution, in accordance with one or more embodiments of the disclosure.

FIG. 9 is a graphical representation of sol-gel particle size as a function of volume of dispensed sol-gel precursor solution droplet, in accordance with one or more embodiments of the disclosure.

FIG. 10 is a graphical representation of sol-gel particle size as a function of annealing temperature, in accordance with one or more embodiments of the disclosure.

FIG. 11 is a graphical representation of sol-gel particle size as a function of percent of TEOS in a sol-gel precursor solution, in accordance with one or more embodiments of the disclosure.

FIG. 12A is a graphical representation of sol-gel particle mass as a function of volume of dispensed precursor solution droplet after 4 hours of drying time, in accordance with one or more embodiments of the disclosure.

FIG. 12B is a graphical representation of sol-gel particle mass as a function of volume of dispensed precursor solution droplet after 8 to 10 days of drying.

### DETAILED DESCRIPTION

Advanced manufacturing systems and methods for producing a glassy material or a ceramic material (e.g., sol-gel particles) are disclosed. The glassy material (e.g., vitreous material) may be silicon-based or metal-based, such as including sol-gel particles of silicon or of a metal. The metal may include, but is not limited to, titanium, aluminum, germanium, zirconium, tin, or combinations thereof. Therefore, the sol-gel particles may include, by way of example only, silicon, titanium, aluminum, germanium, zirconium, tin, or a combination of silicon and one or more of the metals. The silicon and/or metal(s) may be polymerized to form networked polymeric chains within the sol-gel particles. The sol-gel particles also include one or more dopants, such as one or more radionuclides (e.g., radioisotopes), one or more stable (i.e., non-radioactive) chemical elements or chemical compounds, a combination of a radionuclide and a stable element, or a combination of radionuclides and stable elements and/or stable compounds. The sol-gel particles may be formed from a sol-gel precursor and one or more dopants. In some embodiments, dopants include one or more radionuclides. In other embodiments, dopants include one or more stable chemical elements or stable chemical compounds. In yet other embodiments, dopants include one or more radionuclides and one or more stable chemical elements or stable chemical compounds. The dopant(s) are dispersed throughout the sol-gel particles. In some embodiments, the dopant(s) are substantially evenly (e.g., substantially homogeneously) dispersed throughout the sol-gel particles. A predetermined amount of a dopant may be present (e.g., encapsulated) in the sol-gel particles, with the amount of a dopant being tailorable depending on a desired application for the sol-gel particles. Accordingly, the amount of dopant(s) present in the sol-gel particles is quantitatively determinable. By providing sol-gel particles having a quantitatively determinable amount of dopant homogenously distributed throughout, the sol-gel particles produced in accordance with embodiments of the disclosure may be used as a measurement material or in other applications. As used herein, the phrase “quantitatively determinable” shall mean an amount which may be verified within acceptable measurement tolerances.

The advanced manufacturing systems and methods according to embodiments of the disclosure enable the production of sol-gel particles having a desired chemical composition. By selecting the appropriate sol-gel precursor and dopant, the chemical composition of the sol-gel particles may be precisely tailored using the systems and methods according to embodiments of the disclosure. The advanced manufacturing systems and methods according to embodiments of the disclosure may also enable a desired particle size of the sol-gel particles to be formed. Specifically, by adjusting conditions of the systems and methods according to embodiments of the disclosure, the effective particle size of the sol-gel particles may be tailored to achieve a desired criteria. A shape of the sol-gel particles may also be tailored using the advanced manufacturing systems and methods according to embodiments of the disclosure. The resulting sol-gel particles may be spherical, substantially spherical, hemispherical, or other desired shapes.

Conventional fused deposition modeling (FDM) and fused filament fabrication (FFF) type 3D printing systems and methods utilize a solid-based precursor (e.g., a solid thermoplastic filament) which is extruded through a nozzle to produce additively manufactured products. In contrast, the advanced manufacturing systems and methods according to embodiments of the disclosure utilize a liquid-based sol-gel precursor (e.g., a sol-gel precursor solution) which is transferred to a dispensing unit of a modified FDM/FFF type 3D printing system, which dispenses precisely controlled amounts of the sol-gel precursor solution onto a print surface. The advanced manufacturing systems and methods according to embodiments of the disclosure may be utilized to produce the sol-gel particles in amounts of at least grams per day, or at least kilograms per day.

The illustrations presented herein are not actual views of any sol-gel particles or systems, or any component thereof, but are merely idealized representations, which are employed to describe embodiments of the disclosure.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements when utilized in a conventional manner. Furthermore, these terms may refer to an orientation of elements as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

The sol-gel precursor solution may be used to form sol-gel particles in accordance with the systems and methods of one or more embodiments of the disclosure. The sol-gel precursor may be a salt compound, an alkoxide compound, or an oxide compound of silicon or of a metal. The salt may, for example, be a nitrate or a chloride of silicon or of the metal. The alkoxide compound may, for example, be a methoxide, ethoxide, propoxide, or butoxide of silicon or of the metal. The oxide compound may be an oxide of silicon or of the metal. By way of example, a silicon precursor may be used to form silica-based sol-gel particles. The silicon precursor may be a silicon-alkoxy monomer including, but is not limited to, tetramethyl orthosilicate (TMOS), tetraethyl orthosilicate (TEOS), tetrapropyl orthosilicate, tetrabutyl orthosilicate, or other alkoxy compound. Alternatively, the silicon precursor may be silicon tetrachloride, methyltrichloro-silane, or ethyltrichlorosilane. In some embodiments, the sol-gel precursor is TEOS. In some embodiments, the sol-gel precursor is TMOS. If titanium-based sol-gel particles are to be formed, a titanium precursor may be used. The titanium precursor may be an alkyl titanate, such as tetrabutyl titanate. If aluminum-based sol-gel particles are to be formed, an aluminum precursor may be used. The aluminum precursor may be aluminum oxide, aluminum hydroxide, aluminum acetate, aluminum isopropoxide, or a combination thereof. If germanium-based sol-gel particles are to be formed, a germanium precursor may be used. The germanium precursor may be ethyltriethoxygermane, allyltrichloro-germane, n-butyltrichlorogermane, or a combination thereof. If zirconium-based sol-gel particles are to be formed, a zirconium precursor may be used. The zirconium precursor may be zirconium n-propoxide, zirconium oxychloride, or a combination thereof. If tin-based sol-gel particles are to be formed, a tin precursor may be used. The tin precursor may be tributyl [(methoxymethoxy)methyl]stannane, dibutyltin diacetate, an organo-ethoxy tin compound, or a combination thereof. The organo-ethoxy tin compound may comprise a butyl- or higher carbon alkane, such as a butyl-ethoxy tin compound, a pentyl-ethoxy tin compound, a hexyl-ethoxy tin compound, a heptyl-ethoxy tin compound, an octyl-ethoxy tin compound, etc. As described before, other metals, either alone or in combination, may be utilized as a precursor in accordance with one or more embodiments of the disclosure.

The sol-gel precursor solution includes the sol-gel precursor, an acid, at least one solvent, and the one or more dopants. The solvent may be aqueous or organic and may include, by way of example only, water or an organic solvent. A sol-gel precursor, an organic solvent, and water may be substantially miscible with one another. An organic phase may initially form including the organic solvent and the sol-gel precursor, and an aqueous phase may initially form including water and an acid, forming an acidic aqueous phase, however, the organic phase is relatively miscible with the aqueous phase. In some embodiments, the organic phase includes ethanol and the sol-gel precursor and the aqueous phase includes water and the acid. The organic solvent and water are present in relative amounts sufficient to solubilize the sol-gel precursor and the dopant(s). By carefully combining the organic and aqueous phases, the dopant may be substantially evenly dispersed within the solution, enabling substantially homogeneous distribution of the dopant in the sol-gel particles formed therefrom.

The acid in the sol-gel precursor solution may include, but is not limited to, nitric acid, phosphoric acid, hydrochloric acid, ascorbic acid, hydrofluoric acid, or a combination thereof. The advanced manufacturing systems and methods according to embodiments of the disclosure use the acid as a catalyst for the polymerization of the sol-gel precursor(s), as opposed to other processes that use a base catalyst. The acid catalyzed polymerization of the sol-gel precursor results in the formation of the networked polymeric chains, as opposed to colloidal particles which result from a base catalyzed polymerization. The networked polymeric chains entrap (e.g., encapsulate) the dopant or dopants present in the sol-gel precursor solution and assure substantially homogenous distribution of the dopant(s) throughout the sol-gel particles formed therefrom. In some embodiments, the acid is nitric acid. In other embodiments, the acid is ascorbic acid. For example, if the sol-gel precursor is a silicon precursor (e.g., TEOS), the acid may catalyze the polymerization of TEOS to form silicate-based sol-gel particles.

The amount of the sol-gel precursor relative to the amount of the solvent in the sol-gel precursor solution may be expressed as a ratio of from about 1:1 volume/volume (v/v) to about 2:1 v/v. Further, if the sol-gel precursor solution includes an organic solvent and water, the relative amount of the organic solvent to an aqueous fraction may be expressed as a ratio of about 1:2.5 v/v to about 1:10 v/v, where the aqueous fraction includes amounts of water and the acid.

In the presence of the acid catalyst, the sol-gel precursor undergoes hydrolysis and condensation reactions to form the networked polymeric chains that encapsulate the dopant or dopants. As the sol-gel precursor polymerizes, a colloidal solution (sol) is formed that then further polymerizes to form the networked polymeric chains (gel) which encapsulate the dopant or dopants. Upon reacting with water, the sol-gel particles of an oxide of silicon or of the metal are formed. If, for example, the sol-gel precursor is TEOS, silica particles (SiO₂) are formed, which are then hydrolyzed by an acidic aqueous solution to a silicon-hydroxyl (Si—OH). Two hydrolyzed monomers containing Si—OH bonds are then condensed to form a siloxane network (Si—O—Si) along with H₂O, which further condense to form the networked polymeric chains.

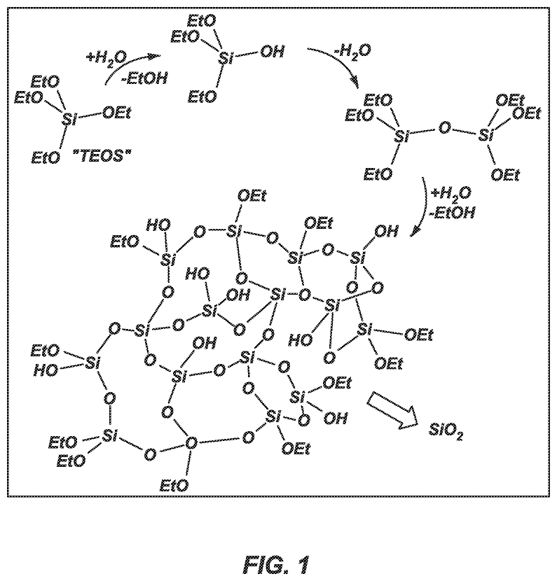

FIG. 1 is a diagrammatic representation of a polymerization reaction of a sol-gel precursor in solution, in accordance with one or more embodiments of the disclosure. More specifically, a TEOS sol-gel precursor is reacted with water in solution to form orthosilicic acid and ethanol by a hydrolysis reaction. The orthosilicic acid condenses to form the networked polymeric chains (e.g., a siloxane network) and water by a condensation reaction. The networked polymeric chains are a reaction product of the sol-gel precursor, and include silicon or a metal depending on the sol-gel precursor used.

Predetermined amounts of one or more dopants (e.g., radionuclides and/or stable elements and/or compounds) are present in the sol-gel precursor solution sufficient to achieve the desired dopant concentration in the sol-gel particles. The dopant(s) may be present at a concentration of up to about 80.0 mol %. By way of example only, the dopant(s) may be present at from about 2.5 mol % to about 80.0 mol %, such as from about 2.5 mol % to about 60.0 mol %, from about 2.5 mol % to about 50.0 mol %, from about 2.5 mol % to about 40.0 mol %, from about 2.5 mol % to about 30.0 mol %, from about 5.0 mol % to about 60.0 mol %, from about 5.0 mol % to about 50.0 mol %, from about 5.0 mol % to about 40.0 mol %, from about 5.0 mol % to about 30.0 mol %, from about 10.0 mol % to about 60.0 mol %, from about 10.0 mol % to about 50.0 mol %, from about 10.0 mol % to about 40.0 mol %, from about 10.0 mol % to about 30.0 mol %, from about 20.0 mol % to about 60.0 mol %, from about 30.0 mol % to about 60.0 mol %, from about 40.0 mol % to about 60.0 mol %, from about 5.0 mol % to about 50.0 mol %, from about 5.0 mol % to about 40.0 mol %, from about 5.0 mol % to about 30.0 mol %, from about 5.0 mol % to about 20.0 mol %, or from about 5.0 mol % to about 10.0 mol %.

The dopant(s) may be a radioactive element and/or a stable element including, but not limited to, hydrogen (H: 3H), scandium (Sc: 44Sc, 46Sc, 47Sc, 48Sc), nickel (Ni: 56Ni, 57Ni, 59Ni, 63Ni, 65Ni, 66Ni), copper (Cu; 66Cu, 67Cu), zinc (Zn: 69Zn, 71Zn, 72Zn), gallium (Ga: 72Ga, 73Ga), germanium (Ge: 73Ge, 75Ge, 77Ge, 78Ge), arsenic (As: 76As, 77As, 78As), selenium (Se: 81Se), bromine (Br: 80Br, 82Br, 83Br, 84Br), krypton (Kr: 85Kr, 87Kr, 88Kr), rubidium (Rb: 86Rb, 88Rb), strontium (Sr: 89Sr, 90Sr, 91Sr, 92Sr), yttrium (Y: 90Y, 91Y, 92Y, 93Y), zirconium (Zr: 95Zr, 97Zr), niobium (Nb: 95Nb, 96Nb, 97Nb), molybdenum (Mo: 99Mo), ruthenium (Ru: 103Ru, 105Ru, 106Ru), rhodium (Rh: 105Rh, 106Rh), palladium (Pd: 109Pd, 111Pd, 112Pd), silver (Ag: 111Ag, 112Ag, 113Ag), cadmium (Cd: 115Cd, 117Cd, 118Cd), indium (In: 117In, 118In), tin (Sn: 121Sn, 123Sn, 125Sn, 127Sn, 128Sn), antimony (Sb: 124Sb, 125Sb, 126Sb, 127Sb, 128Sb, 129Sb, 130Sb), tellurium (Te: 127Te, 129Te, 131Te, 132Te, 133Te, 134Te), iodine (I: 130I, 131I, 132I, 133I, 134I, 135I), xenon (Xe: 133Xe, 135Xe), cesium (Cs: 136Cs, 137Cs, 138Cs), barium (Ba: 139Ba, 140Ba), lanthanum (La: 140La, 141La, 142La), cerium (Ce: 141Ce, 143Ce, 144Ce), praseodymium (Pr: 143Pr, 144Pr, 145Pr), neodymium (Nd: 147Nd, 149Nd), promethium (Pm: 147Pm, 149Pm, 150Pm, 151Pm), samarium (Sm: 151Sm, 153Sm, 156Sm), europium (Eu: 152Eu, 154Eu, 155Eu, 156Eu, 157Eu, 158Eu), gadolinium (Gd: 159Gd), terbium (Tb: 161Tb), dysprosium (Dy: 165Dy, 166Dy), plutonium (Pu: 238Pu, 239Pu, 240Pu, 241Pu, 242Pu), americium (Am: 240Am, 241Am, 242Am, 243Am), curium (Cm: 240Cm, 241Cm, 242Cm, 243Cm, 244Cm), tungsten (W: 178W, 179W, 181W, 185W, 187W, 188W), lutetium (Lu: 169Lu, 170Lu, 171Lu, 172Lu, 173Lu, 174Lu, 177Lu), neptunium (Np: 237Np), cobalt (Co: 56Co, 57Co, 58Co, 60Co, 61Co), uranium (U: 234U, 235U, 237U), carbon (C: 14C), silicon (Si: 32Si), sodium (Na: 22Na), aluminum (Al: 26Al), phosphorus (P: 32P, 33P), sulfur (S: 35S), chlorine (Cl: 36K), potassium (K: 42K, 43K), calcium (Ca: 45Ca, 47Ca), titanium (Ti: 44Ti, 45Ti), vanadium (V: 48V, 49V), iron (Fe: 55Fe, 59Fe, 60Fe), chrome (Cr: 51Cr), manganese (Mn: 52Mn, 53Mn, 54Mn), holmium (Ho: 163Ho, 166Ho, 167Ho), erbium (Er: Er160, Er163, Er165, Er169, Er171, Er172), thulium (Tm: 165Tm, 167Tm, 168Tm, 170Tm, 171Tm, 172Tm, 173Tm), ytterbium (Yb: 166Yb, 169Yb, 169Yb, 175Yb, 177Yb), hafnium (Hf: 172Hf, 173Hf, 175Hf, 181Hf, 182Hf, 183Hf, 184Hf), tantalum (Ta: 177Ta, 178Ta, 179Ta, 182Ta, 183Ta, 184Ta), osmium (Os: Os185, Os191, Os193, Os194), iridium (Ir: 187Ir, 188Ir, 190Ir, 192Ir, 193Ir, 194Ir, 195Ir, 196Ir), platinum (Pt: 188Pt, 189Pt, 193Pt, 195Pt, 197Pt), gold (Au: 193Au, 194Au, 195Au, 196Au, 198Au, 199Au, 200Au), thallium (Tl: 199T1, 200T1, 201T1, 202T1, 204T1), lead (Pb: 202Pb, 203Pb, 205Pb, 209Pb, 210Pb), bismuth (Bi: 205Bi, 206Bi, 207Bi, 208Bi, 210Bi), polonium (Po: 206Po, 208Po, 210Po), radium (Ra: 223Ra, 224Ra, 225Ra, 226Ra, 228Ra), actinium (Ac: 209Ac, 225Ac, 226Ac, 227Ac), thorium (Th: 227Th, 228Th, 229Th, 230Th, 231Th, 232Th, 234Th), or combinations thereof.

The dopant(s) are incorporated into a sol-gel precursor solution in predetermined measured amounts and are encapsulated within the networked polymeric chains producing sol-gel particles having a quantitatively determinable amount of a radionuclide and/or stable component (e.g., stable element or stable compound) evenly dispersed or homogenously distributed throughout, in accordance with at least some embodiments of the disclosure. As such, the sol-gel particles produced in accordance with the advanced manufacturing systems and methods of the disclosure may be utilized as surrogate debris particles having specific and tunable amounts of the radionuclide(s) and/or stable component(s) to simulate nuclear debris. For example, in some embodiments, uranium fission products (e.g., Mo, Ba, Sr, Zr, Nd, Ce, etc.), which may be present in nuclear fallout, may be incorporated into a sol-gel precursor solution and used to form sol-gel particles that are homogeneous with respect to the final mass of dopant per mass of final sol-gel particle produced. In other embodiments, radionuclide(s) may include Fe, Al, Ca, Na, or a combination thereof, to produce sol-gel particles which simulate soils, ceramics, geologic materials, and silica- or calcium-based nuclear fallout. Further, sol-gel particles may be produced having specific and tunable amounts of radionuclide(s) and/or stable component(s) for use in other fields, for example, as a quantitatively determinable source of radioisotopes for use in nuclear medicine treatment regimens.

In addition to serving as a quantitatively determinable dopant, the radionuclide may provide a desired color (e.g., green, black, red, etc.), degree of reflectivity (e.g., shiny, dull), and/or opacity (e.g., transparent, translucent, opaque) to the sol-gel particles. Alternatively or additionally, a stable chemical element or a stable chemical compound may be incorporated into a sol-gel precursor solution to produce sol-gel particles having a desired color, reflectivity, and/or opacity.

The particle size (e.g., effective diameter) of the sol-gel particles formed in accordance with the systems and methods of the disclosure may range from about 0.01 mm (10 μm) to greater than about 3.0 mm (3000 μm), such as from about 0.3 mm to about 2.0 mm from about 0.4 mm to about 1.8 mm, from about 0.4 mm to about 1.5 mm, or from about 0.5 mm to about 1.4 mm. In some embodiments, the particle size of the sol-gel particles is greater than or equal to about 500 μm. However, smaller particle sizes of the sol-gel particles may also be formed, such as a particle size of less than or equal to about 0.01 mm. If the sol-gel particles are flat discs, hemispherical, or non-spherical shapes, the particle sizes may be greater than about 3.0 mm (3000 μm).

The sol-gel particles may be formed (e.g., cast) by a controllable technique that enables the particle size, shape, and chemical composition to be tailored. By dissolving the sol-gel precursor, dopant, and other ingredients in solution, the dopant may be substantially homogeneous dispersed in the sol-gel particles formed from the sol-gel precursor solution. The formation of the sol-gel particles is also robust, enabling the process to be conducted autonomously and potentially within a radiological hot cell or glovebox environment. The process may also be conducted in a remote radioactive or automated clean room environment. The advanced manufacturing systems and methods according to embodiments of the disclosure may also be used to form the sol-gel particles without chemical fractionation.

After forming the solution of the sol-gel precursor, such as by combining the sol-gel precursor, the acid, the dopant (e.g., the radionuclide), and the one or more solvents, the sol-gel particles may be formed by a drop-cast process. The drop-cast process may be conducted using a modified 3D printing system. Small volumes of the sol-gel precursor solution are drawn from a stock solution, such as by a metering pump or other precision fluid transfer mechanism, and are dispensed onto a surface (e.g., a print surface, a build surface) to form (e.g., cast) droplets containing the sol-gel precursor on the print surface. The sol-gel precursor solution may be dispensed by pipette or other dispenser configured to precisely dispense small volumes of the sol-gel precursor solution. The droplets of the sol-gel precursor solution may be dispensed onto a hydrophobic print surface or a hydrophilic print surface. Interactions between the droplets and the hydrophobic print surface cause the droplets to form into (e.g., bead into) a desired shape. The droplets are allowed to gel and dry on the print surface, forming the sol-gel particles according to embodiments of the disclosure. The dopant may be homogeneously dispersed throughout the resulting sol-gel particles. By adjusting the composition of the sol-gel precursor solution and the print surface, particle shapes ranging from flat discs to cylinders to hemispheres to substantially spherical to spherical spheres may be formed. Other shapes as desired may also be produced based upon the manner in which the sol-gel precursor solution is dispensed upon the surface. The sol-gel precursor solution containing the homogeneously dispersed dopant may be cast into small droplets with high throughput, ensuring that each droplet contains the same ratios of each encapsulated element, such as the one or more radionuclides.

In addition to dopant composition and concentration, particle size and mass of sol-gel particles formed, the geometric shape of the sol-gel particles formed in accordance with one or more embodiments of the disclosure may also be tailored as needed for specific end uses. Modifying the hydrophobicity of a contact surface (e.g., print surface) and/or the surface tension of the sol-gel precursor solution enables a contact angle of the sol-gel particles with the contact surface to be adjusted, which affects both the particle size and the geometric shape of the sol-gel particles. As one example, the surface tension of the sol-gel precursor solution may be modified by adjusting the ratio of organic solvent to water in the sol-gel precursor solution. By modifying the contact surface (e.g., print surface) to exhibit high hydrophobicity, combined with a high surface tension of the sol-gel precursor solution, substantially spherical sol-gel particles exhibiting a substantially high contact angle may be produced. For instance, the contact angle may be greater than about 90 degrees, such as greater than about 100 degrees, greater than about 110 degrees, greater than about 120 degrees, greater than about 130 degrees, greater than about 140 degrees, or greater than about 160 degrees.

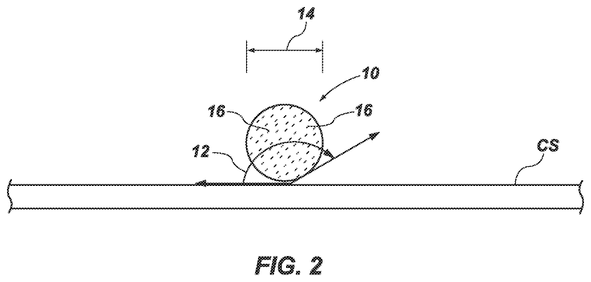

FIG. 2 is a diagrammatic representation of a sol-gel particle 10 disposed on a contact surface CS and having a dopant 16 dispersed therein, in accordance with one or more embodiments of the disclosure. As may be seen from FIG. 2, the dopant 16 is substantially homogenously distributed throughout the sol-gel particle 10. As further shown in FIG. 2, the sol-gel particle 10 comprises a substantially spherical configuration which forms a contact angle 12 of about 140 degrees with the contact surface CS. The sol-gel particle size, i.e., the sol-gel particle effective diameter 14, is also illustrated in FIG. 2. The effective diameter 14 of the sol-gel particles produced in accordance with some embodiments of the disclosure may range from about 0.01 mm (10 μm) to greater than about 3.0 mm (3000 μm). As will be appreciated, as the geometric configuration of the sol-gel particle 10 becomes less spherical, e.g., hemispherical, the contact angle 12 with the contact surface will decrease, and the particle size, i.e., the effective diameter 14, of the sol-gel particle 10 will increase.

Thus, in accordance with one or more embodiments of the disclosure, sol-gel particles may be formed by a controllable technique that enables the sol-gel particle size, shape and dopant composition and concentration to be specifically tailored as needed for a particular end use. By way of example only, the sol-gel particles formed in accordance with the disclosure may be used in various applications including, but not limited to, nuclear surrogates for use in emergency response exercises and training, sources of controlled release of radioisotopes in nuclear medicine treatment regimens, microscopy techniques including imaging, elemental analyses, and microscale mass spectrometry (e.g., secondary ion mass spectrometry (SIMS)), or as measurement materials. The substantially homogeneous sol-gel particles may, for example, be used as surrogate debris particles to simulate nuclear debris for training nuclear first responders and to validate nuclear forensics techniques. The surrogate debris particles may be similar in size, color, elemental composition, and radionuclide content to actual nuclear debris. For medical applications, the particle size of the sol-gel particles must be precisely carefully controlled as deviations outside specific tolerances may result in inconsistent therapeutic results, and/or potential loss of radioactive materials, which may be extremely dangerous, or otherwise detrimental. In addition to sol-gel particles, the advanced manufacturing systems and methods in accordance with at least some embodiments of the disclosure may also be used to form ceramic or other solution-based particles.

Having now described the properties of the sol-gel particles which may be produced in accordance with one or more embodiments of the disclosure, presented below with reference to the figures are advanced manufacturing systems and methods of producing sol-gel particles.

After forming a sol-gel precursor solution, such as by combining a sol-gel precursor, an acid, one or more solvents, and one or more dopants (e.g., radionuclides), sol-gel particles including one or more dopants may be formed by a drop-cast process. The drop-cast process may be performed, by way of example, utilizing a modified FDM/FFF type 3D printing system. While advanced manufacturing systems and methods according to embodiments of the disclosure are described herein as using a modified FDM/FFF 3D printing system, other types of 3D printing systems may also be modified and used.

As described before, conventional FDM/FFF type 3D printing systems utilize a solid-based precursor (e.g., a solid thermoplastic filament) which is extruded through a nozzle to generate additive manufactured products. The advanced manufacturing systems and methods in accordance with the disclosure utilize a liquid-based sol-gel precursor solution which is transferred to a dispensing unit of a modified FDM/FFF type 3D printing system, wherein the dispensing unit dispenses precisely controlled amounts (e.g., volumes) of the sol-gel precursor solution onto a print surface.

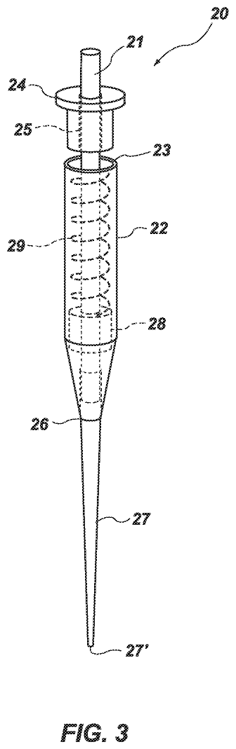

With reference to FIG. 3, presented therein is a diagrammatic representation of a sol-gel precursor solution dispensing unit 20, in accordance with one or more embodiments of the disclosure. The dispensing unit 20 includes a pipette 22 having a proximal end 23 and a distal end 26. In at least some embodiments, the distal end 26 of the pipette comprises a tapered configuration, such as may be seen from FIG. 3. A pipette tip 27 having an elongated configuration is dimensioned and configured to be inserted at least partially into the pipette 22 through the distal end 26 thereof. The pipette 27 has a dispensing aperture 27′ formed through a lower end through which droplets of the sol-gel precursor solution of a precise preselected volume are dispensed. In accordance with some embodiments of the disclosure, the pipette tip 27 comprises a 10 μL pipette tip and is configured with a limited surface area onto which the sol-gel-precursor solution may adhere, thereby enabling precise dispensing droplets of the sol-gel precursor solution having very small volumes. The sol-gel precursor solution droplets 18 may have a preselected volume in a range of nanoliters to milliliters. For example, the sol-gel precursor solution droplets 18 may have a volume ranging from about 1 nanoliter to about 1 milliliter, from about 1 nanoliter to about 100 microliters, or from about 1 nanoliter to about 25 microliters. Precise control of the volume of the sol-gel precursor solution dispensed onto a surface (e.g., print surface) allows for the particle size of the sol-gel particles produced to also be precisely controlled.

An end cap 24 is dimensioned and configured to fit snuggly within the proximal end 23 of the pipette 22 and is retained therein by way of a friction fit, for example. In at least some embodiments, the end cap 24 includes a conduit channel 25 formed therethrough. A supply conduit 21 is disposed in fluid communication with a precursor solution transfer unit 124, 224, disclosed in detail hereinafter, and is disposed into and through the conduit channel 25 of the end cap 24; through the pipette 22; and into an upper end of the pipette tip 27, as best shown in FIG. 3.

A conduit stop 28 is affixed to a portion of the supply conduit 21 proximate the upper end of the pipette tip 27. The conduit stop 28 is dimensioned and configured so as to abut the inner sidewalls of the pipette 22, for example, proximate the tapered distal end 26 of the pipette 22, so as to inhibit further downward movement of the conduit stop 28, and thus, inhibiting further downward movement of the supply conduit 21 affixed thereto, into the pipette 22, once again, as shown best in FIG. 3.

A biasing member 29 is disposed between a lower end of the end cap 24 and the upper end of the conduit stop 28. As will be appreciated, when the end cap 24 is operatively positioned into the proximal end 23 of the pipette 22, the lower end of the end cap 24 will contact the biasing member 29 and will compress the biasing member 29 against the upper end of the conduit stop 28, thereby applying an amount of pressure thereto. The pressure applied by the biasing member 29 to the conduit stop 28 is sufficient to retain the portion of the supply conduit 21 in the upper end of the pipette tip 27 during operation.

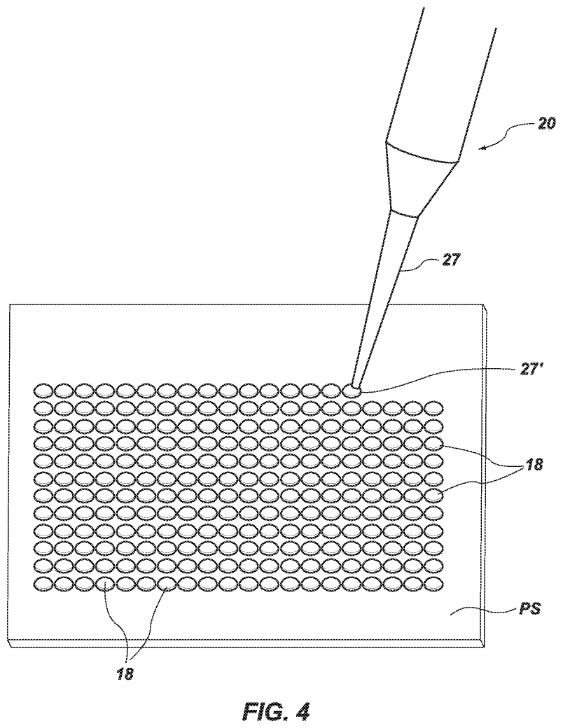

FIG. 4 is illustrative of one embodiment of a dispensing unit 20 dispensing sol-gel precursor solution droplets 18 onto a print surface PS. The pipette tip 27 of the dispensing unit 20 comprises a dispensing aperture 27′ which is dimensioned and configured to dispense sol-gel precursor solution droplets 18 of a precisely controlled preselected volume. As described before, through precise control of the volume of the sol-gel precursor solution droplets 18 dispensed onto a print surface in accordance with the disclosure, the particle size or effective diameter 14 of the sol-gel particles 10 produced in accordance with the disclosure may also be precisely controlled.

As may be seen from FIG. 4, in at least some embodiments, the dispensing unit 20 dispenses sol-gel precursor solution droplets 18 onto the print surface PS in a tightly packed array of aligned rows and columns. Spacing between individual sol-gel precursor solution droplets 18 is dependent on a number of factors including, but not limited to, the volume of the sol-gel precursor solution droplets 18, the surface tension and/or viscosity of the sol-gel precursor solution, and the hydrophobicity of the print surface. Regardless of the spacing, a control unit 118, 218 of a modified 3D printing system, disclosed in further detail hereinafter, may be programmed to achieve the precise spacing between the sol-gel precursor solution droplets 18 on the print surface.

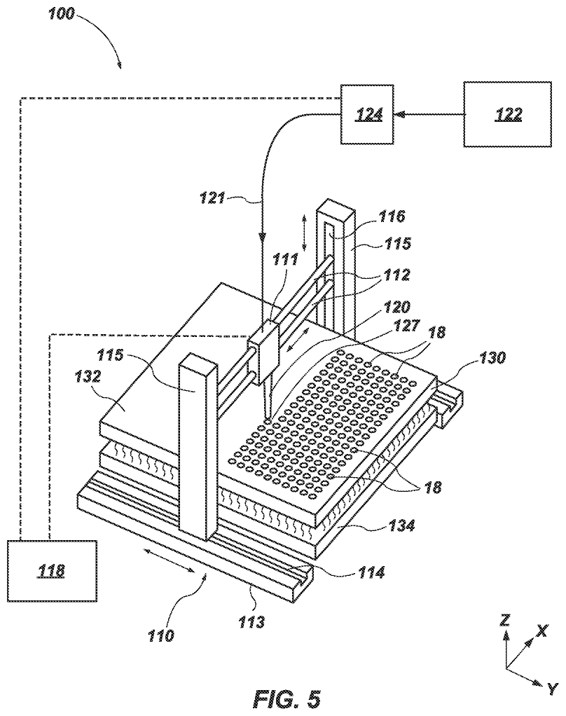

With reference next to FIG. 5, presented therein is a diagrammatic representation of a sol-gel particle production system 100 configured to form the sol-gel particles in a batch process, in accordance with one or more embodiments of the disclosure. A batch sol-gel particle production system 100 includes a transport assembly 110. In some embodiments, a transport assembly 110 comprises components of a conventional FDM/FFF type 3D printing system. For purposes of clarity, many of the smaller components of the transport assembly 110 such as the individual transport motors, belts, wheels, pulleys, etc., which effect movement of the various components are not shown in the figures.

To begin, a transport assembly 110 of the sol-gel particle production system 100 includes a transport unit 111. The transport unit 111 of the transport assembly 110 is positionable over and along a print surface 132 on a print plate 130 of the batch sol-gel particle production system 100. As shown in FIG. 5, a dispensing unit 120, similar to dispensing unit 20 disclosed and described hereinabove, is mounted to a portion of the transport unit 111 and is moveable therewith, i.e., the dispensing unit 120 is positionable over and along the print surface 132 with the transport unit 111. As shown in FIG. 5, a single dispensing unit 120 is mounted to the transport unit 111. However, it is to be appreciated that in some embodiments of the disclosure, a batch sol-gel particle production system 100 may include multiple dispensing units 120 mounted to a transport unit 111, thereby allowing multiple sol-gel precursor solution droplets 18 to be dispensed onto the print surface 132 at substantially the same time.

The transport assembly 110 includes at least one horizontal support 113 having a vertical support 115 interconnected thereto. The horizontal support 113 includes a y-axis track 114, and the vertical support 115 is positionable back and forth along the y-axis track 114 in the direction of the y-axis depicted in FIG. 5. In one or more embodiments, a transport assembly 110 includes horizontal supports 113 each having a vertical support 115 interconnected thereto and positionable along the y-axis track 114 of the horizontal support 113. With reference to FIG. 5, the transport assembly 110 includes a pair of horizontal supports 113 each having a vertical support 115 interconnected thereto, the horizontal supports 113 being disposed along opposite sides of a print plate 130. With continued reference to FIG. 5, the vertical supports 115 are positionable along the y-axis tracks 114 of the corresponding horizontal supports 113 in the direction of the y-axis, as depicted by the multidirectional arrow collinear with the y-axis.

The transport unit 111 is operably mounted to one or more x-axis tracks 112, which facilitates positioning the transport unit 111, and thus the dispensing unit 120 mounted thereto, along the x-axis as represented by the multidirectional arrow collinear with the x-axis in FIG. 5. The x-axis tracks 112 are interconnected to at least one vertical support 115, and in some embodiments, the x-axis tracks 112 are interconnected between oppositely disposed vertical supports 115, as shown by way of example in FIG. 5. The vertical supports 115 each include a z-axis track 116, and the x-axis tracks 112 are interconnected to and positionable up and down in the z-axis tracks 116 along the z-axis as represented by the multidirectional arrow collinear with the z-axis in FIG. 5.

As will be appreciated, a transport assembly 110 in accordance with one or more embodiments of the disclosure provides for precise positioning of the dispensing unit 120, and more importantly, precise positioning of the pipette tip 127 of a dispensing unit 120 across and along the print surface 132 of the print plate 130. Further, the distance between a pipette aperture of the pipette tip 127 and the print surface 132 may also be precisely controlled by positioning the x-axis tracks 112 further up or down along the z-axis tracks 116. With reference again to FIG. 5, in at least some embodiments, a control unit 118 is disposed in a communicative relation with the transport assembly 110, for example, in communication with the transport unit 111. The control unit 118 may be programmed to cause the transport unit 111 to move over and along the print surface 132 to allow precise positioning of the pipette tip 127, or pipette tips 127, of the dispensing unit 120 to dispense sol-gel precursor solution droplets 18 in a predetermined array onto the print surface 132. The transport assembly 110 may be configured for positioning in the x, y, and z directions, respectively, relative to the print surface 132. In one or more embodiments, the x-y-z axis transport motors (not shown) of the transport assembly 110 are configured to exhibit a transport precision of less than about 0.2 millimeters.

A batch sol-gel particle production system 100 in accordance with one or more embodiments of the disclosure includes a precursor solution reservoir 122 dimensioned and configured to contain an amount of the sol-gel precursor solution prior to deposition onto a print surface 132. Further, a precursor solution transfer unit 124 is disposed in fluid communication between the precursor solution reservoir 122 and the dispensing unit 120. The precursor solution transfer unit 124 is configured to transfer precise preselected amounts of sol-gel precursor solution from the precursor solution reservoir 122 to the dispensing unit 120 through the supply conduit 121 interconnected thereinbetween for deposition of sol-gel precursor solution droplets 18 each having a precise preselected volume onto the print surface 132. A precursor solution transfer unit 124 may include, but is not limited to, a peristaltic pump, a syringe pump, an array of peristaltic or syringe pumps, or other precision metering pumps.

In at least some embodiments, the control unit 118 is further disposed in a communicative relation with the precursor solution transfer unit 124. The control unit 118 may be programmed to cause the precursor solution transfer unit 124 to transfer precise preselected amounts of the sol-gel precursor solution to the dispensing unit 120 to assure that the sol-gel precursor solution droplets 18 dispensed through the pipette tip 127 onto the print surface 132 each comprise a precise preselected volume. By way of example, the control unit 118 may be programmed to control the rate at which the sol-gel precursor solution is transferred from the precursor solution reservoir 122 to the dispensing unit 120 by the precursor solution transfer unit 124.

As described before, in at least some embodiments, a batch sol-gel particle production system 100 may include multiple dispensing units 120 mounted to a transport unit 111 and positionable therewith, in which case, the precursor solution transfer unit 124 may be configured to transfer precise preselected amounts of sol-gel precursor solution from the precursor solution reservoir 122 to each of the dispensing units 120 through supply conduits 121 interconnected thereinbetween. The sol-gel precursor solution may be transferred by the precursor solution transfer unit 124 to different microchannel tubes to enable dispensing multiple sol-gel precursor solution droplets 18 onto the print surface 132 at a time, once again, wherein each of the sol-gel precursor solution droplets 18 have a precise preselected volume. The microchannel tubes may be dimensioned and configured to dispense a consistent preselected volume of the sol-gel precursor solution therethrough. Thus, the sol-gel precursor solution droplets 18 may be dispensed onto a print surface 132 each having a precise preselected volume by the microchannel pipettes at rates of dozens or more sol-gel precursor solution droplets 18 at a time.

As disclosed above, a batch sol-gel particle production system 100 in accordance with one or more embodiments of the disclosure includes a print plate 130 having a print surface 132 disposed thereon. In some embodiments, the print surface 132 may comprise the same material of construction as the print plate 130. In other embodiments, a print surface 132 comprises a different material of construction than the underlying print plate 130. The print surface 132 may be flat (e.g., planar) or substantially flat (e.g., substantially planar) and formed from glass, plastic, metal, or other material. Depending on the desired shape and effective diameter 14 of the sol-gel particles 10 to be produced, the print surface 132 may be modified, such as by altering the hydrophobicity of the print surface 132. The hydrophobicity of the print surface 132 may be increased or decreased, which affects the desired shape of the sol-gel particles 10 formed thereon. By adjusting the hydrophobicity or hydrophilicity of the print surface 132, the shape, and thus, the effective diameter 14, of the sol-gel particles 10 formed thereon may be specifically tailored to meet the needs of a particular end use. A relatively more hydrophilic print surface 132 may be used to form disc-shaped or hemispheric sol-gel particles 10. Conversely, a relatively more hydrophobic print surface 132 may be used to form more spherical or even substantially spherical sol-gel particles 10. The hydrophobicity of a print surface 132 may be increased by forming a fluoropolymer coating, such as a coating of polytetrafluoroethylene (PTFE), on the print surface 132. The PTFE may, for example, be a flexible polytetrafluoroethylene commonly known as BYTAC®, a registered trademark of Saint-Gobain Performance Plastics Corp., or a superhydrophobic fluoropolymer material such as SH-PTFE™ sold by IRPI LLC of Wilsonville, Oregon.

By way of example only, if disc shaped sol-gel particles 10 are to be formed, a low surface tension sol-gel precursor solution may be used alone or in combination with a weakly hydrophobic print surface 132. If hemispherical sol-gel particles 10 are to be formed, a moderate surface tension sol-gel precursor solution may be used with a moderately hydrophobic print surface 132 to achieve the desired surface interactions. To produce spherical or substantially spherical sol-gel particles 10, an extremely hydrophobic print surface 132 and high surface tension sol-gel precursor solution may be used.

Once the sol-gel precursor solution droplets are formed on the print surface 132, in at least some embodiments, the print surface 132 may be removed from the print plate 130 and transferred to a drying area, and another (e.g., empty) print surface 132 may be positioned on the print plate 130 ready to receive another array of sol-gel precursor solution droplets 18 thereon, thus allowing the batch sol-gel particle production system 100 to operate in a semi-continuous process mode. The process may then be repeated to form multiple print surfaces 132 each filled with the sol-gel precursor solution droplets 18 which may be transferred to a drying area until the desired number of sol-gel particles are produced.

The disclosed batch sol-gel particle production system 100 may optionally include a heat source 134, which facilitates drying (e.g., removal of solvents) of the sol-gel precursor solution droplets 18 dispensed onto a print surface 132. The heat source 134 may apply heat directly to the print plate 130 for transfer to the print surface 132, such as is shown by way of example only in FIG. 5. In some embodiments, a batch sol-gel particle production system 100 in accordance with the disclosure includes an external heat source 134, such as a heating chamber or heat lamp.

The sol-gel particles 10 may, optionally, be annealed after dispensing and allowing the sol-gel precursor solution droplets 18 to gel and dry on a print surface 132. The sol-gel particles 10 may be heated to a temperature of from about 300° Celsius to about 700° Celsius, depending on the type and concentration of dopant(s) present in the sol-gel particles 10. The annealing process may change one or more of a structural composition and/or color of the sol-gel particles 10. Higher temperatures may also be used if further changes in the sol-gel particles 10 structure and elemental composition are desired. The sol-gel particles 10 may be annealed in a heat chamber (not shown) which may be external to the batch sol-gel particle production system 100 in accordance with the disclosure.

Annealing sol-gel particles 10 at a preselected temperature for a period of time combined with a precisely controlled volume of the sol-gel precursor solution dispensed onto a surface (e.g., print surface), allows further control over the particle size of the sol-gel particles 10 produced in accordance with one or more of the embodiments of the disclosure.

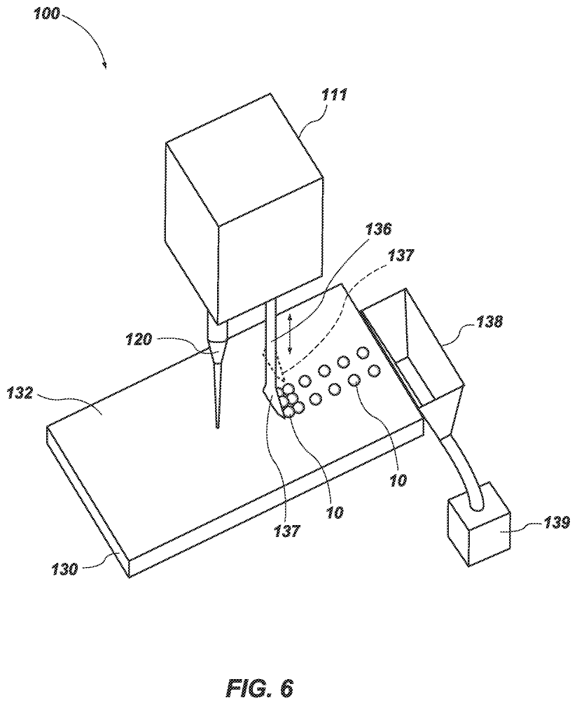

After drying, the resulting sol-gel particles 10 may be in a substantially solid state, such as a rigid solid similar to a glass or a ceramic. The sol-gel particles 10 are then removed from the print surface 132 and transferred to a storage container 139, as shown in FIG. 6. With reference to FIG. 6, in at least some embodiments, a removal tool 136 having a removal head 137 is attached to a portion of a transport unit 111 and is movable therewith. The removal tool 136 may have a fixed length and extend downward from the transport unit 111 a fixed length relative to the dispensing unit 120. Alternatively, the removal tool 136 may comprise a retractable removal head 137 which may be raised or lowered relative to the print surface 132 as needed to allow for deposition of new sol-gel precursor solution droplets 18 or for the removal of dried sol-gel particles 10.

As shown in FIG. 6, once the sol-gel particles 10 have dried, the transport unit 111 may be operated to cause the removal tool 136 to move along and across the print surface 132 such that the removal head 137 engages the dried sol-gel particles 10 and directs them towards one end of the print surface 132 of the print plate 130 having a collection unit 138 disposed proximate thereto. The storage container 139 may be disposed in communication with the collection unit 138, such that the sol-gel particles 10 received by the collection unit 138 may be transferred into the storage container 139 where they may be readied for storage or transport to an end user.

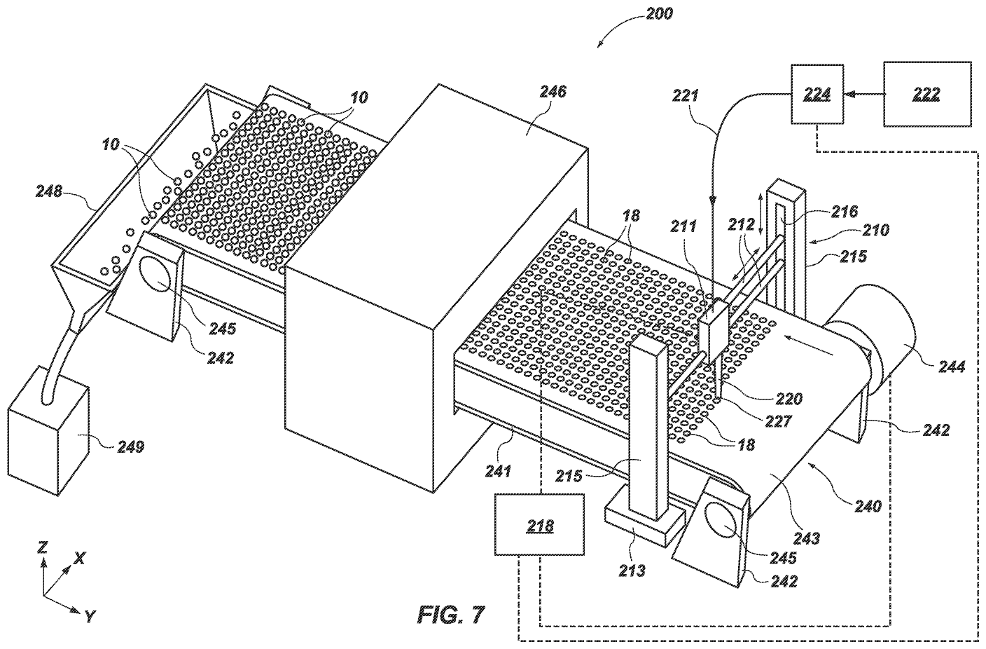

With reference next to FIG. 7, presented therein is a diagrammatic representation of a continuous sol-gel particle production system 200, in accordance with one or more embodiments of the disclosure. A continuous sol-gel particle production system 200 includes a transport assembly 210. In some embodiments, and similar to the batch sol-gel particle production system 100 disclosed hereinabove, a transport assembly 210 comprises components of a conventional FDM/FFF type 3D printing system. Once again, for purposes of clarity, many of the smaller components of the transport assembly 210 such as the individual transport motors, belts, wheels, pulleys, etc., which effect movement of the various components are not shown in the figures.

A transport assembly 210 includes a transport unit 211 which is positionable over and along a print surface 243 of the continuous sol-gel particle production system 200. As shown in FIG. 7, a dispensing unit 220, similar to dispensing units 20, 120 disclosed and described hereinabove, is mounted to a portion of the transport unit 211 and is moveable therewith, i.e., the dispensing unit 220 is positionable over and along the print surface 243 with the transport unit 211. In FIG. 7, a single dispensing unit 220 is shown mounted to the transport unit 211, however, a continuous sol-gel particle production system 200 may include multiple dispensing units 220 mounted to a transport unit 211, allowing multiple sol-gel precursor solution droplets 18 to be dispensed onto the print surface 243 at the same time.

The transport assembly 210 includes at least one horizontal support 213 having a vertical support 215 interconnected thereto. With reference to FIG. 7, the transport assembly 210 includes a pair of horizontal supports 213 each having a vertical support 215 interconnected thereto, the horizontal supports 213 being disposed along opposite sides of a conveyor belt 241 of a conveyor assembly 240.

The transport unit 211 is operably mounted to one or more x-axis tracks 212, which facilitates positioning the transport unit 211, and thus, positioning the dispensing unit 220 mounted thereto, along the x-axis as represented by the multidirectional arrow collinear with the x-axis in FIG. 7. The x-axis tracks 212 are interconnected to at least one vertical support 215, and in some embodiments, the x-axis tracks 212 are interconnected between oppositely disposed vertical supports 215. The vertical supports 215 each include a z-axis track 216, and the x-axis tracks 212 are interconnected to and positionable up and down along the z-axis tracks 216 in the direction of the z-axis as represented by the multidirectional arrow collinear with the z-axis in FIG. 7.

The transport assembly 210 of a continuous sol-gel particle production system 200 in accordance with the disclosure provides for precise positioning of the dispensing unit 220, and more importantly, precise positioning of the pipette tip 227 of a dispensing unit 220 across and along the print surface 243. Further, the distance between a pipette aperture of the pipette tip 227 and the print surface 243 may also be precisely controlled by causing the x-axis tracks 212 to move up or down along the z-axis tracks 216. With reference again to FIG. 7, in at least some embodiments, a control unit 218 is provided and is disposed in a communicative relation with the transport assembly 210, for example, in communication with the transport unit 211. The control unit 218 may be programmed to cause the transport unit 211 to move over and along the print surface 243 to allow precise positioning of the pipette tip 227, or pipette tips 227, of the dispensing unit 220 to dispense sol-gel precursor solution droplets 18 in a predetermined array onto the print surface 243. The transport assembly 210 may be configured for positioning in the x and z directions, respectively, relative to the print surface 243.

With reference once again to FIG. 7, a continuous sol-gel particle production system 200 in accordance with the disclosure includes a conveyor assembly 240. The conveyor assembly 240 includes a conveyor belt 241 and supports 242. The supports 242 are disposed to retain the conveyor belt 241 in an operative position, for example, such as via rollers 245 interconnected between oppositely disposed ones of the supports 242. A conveyor motor 244 is provided to rotate at least one of the rollers 245, thereby causing the conveyor belt 241 to move. In at least some embodiments, the conveyor motor 244 causes the conveyor belt 241 to move along the y-axis rearward from the transport assembly 210 in the direction indicated by the unidirectional arrow collinear with the y-axis in FIG. 7.

The conveyor belt 241 of the conveyor assembly 240 comprises a print surface 243 disposed thereover onto which the sol-gel precursor solution droplets 18 are dispensed. As described before, depending on the desired shape and effective diameter 14 of the sol-gel particles 10 to be produced, the print surface 243 may be modified, such as by altering the hydrophobicity of the print surface 243. The hydrophobicity of the print surface 243 may be increased or decreased which, once again, affects the desired shape of the sol-gel particles 10 formed thereon. By adjusting the hydrophobicity or hydrophilicity of the print surface 243, the shape, and thus, the effective diameter 14, of the sol-gel particles 10 formed thereon may, once again, be specifically tailored to meet the needs of a particular end use. For example, a more hydrophilic print surface 243 may be used to form more disc-shaped or hemispheric sol-gel particles 10. Conversely, a more hydrophobic print surface 243 may be used to form more spherical or even substantially spherical sol-gel particles 10. The hydrophobicity of a print surface 243 may be increased by forming a fluoropolymer coating, such as a coating of polytetrafluoroethylene (PTFE), on the print surface 243. As described before, the PTFE may, for example, be a flexible polytetrafluoroethylene commonly known as BYTAC®, a registered trademark of Saint-Gobain Performance Plastics Corp.

By way of example only, if disc shaped sol-gel particles 10 are to be formed, a low surface tension sol-gel precursor solution may be used alone or in combination with a weakly hydrophobic print surface 243. To form hemispherical sol-gel particles 10, a moderate surface tension sol-gel precursor solution may be used with a moderately hydrophobic print surface 243 to achieve the desired surface interactions. To produce spherical or substantially spherical sol-gel particles 10, an extremely hydrophobic print surface 243 and high surface tension sol-gel precursor solution may be used.

A continuous sol-gel particle production system 200 in accordance with one or more embodiments of the disclosure includes a precursor solution reservoir 222 dimensioned and configured to contain an amount of a sol-gel precursor solution therein prior to deposition onto a print surface 243. A precursor solution transfer unit 224 is disposed in fluid communication between the precursor solution reservoir 222 and the dispensing unit 220. The precursor solution transfer unit 224 is configured to transfer precise preselected amounts of sol-gel precursor solution from the precursor solution reservoir 222 to the dispensing unit 220 through the supply conduit 221 interconnected thereinbetween for deposition of sol-gel precursor solution droplets 18 each having a precise preselected volume onto the print surface 243. A precursor solution transfer unit 224 may include, but is not limited to, a peristaltic pump, a syringe pump, an array of peristaltic or syringe pumps, or other precision metering pumps.

In at least some embodiments, the control unit 218 is further disposed in a communicative relation with the precursor solution transfer unit 224. The control unit 218 may be programmed to cause the precursor solution transfer unit 224 to transfer precise preselected volumes of the sol-gel precursor solution to the dispensing unit 220 to assure that the sol-gel precursor solution droplets 18 dispensed through the pipette tip 227 onto the print surface 243 each comprise a precise preselected volume. By way of example, the control unit 218 may be programmed to control the rate at which the sol-gel precursor solution is transferred from the precursor solution reservoir 222 to the dispensing unit 220 by the precursor solution transfer unit 224. Further, the control unit 218 may be programmed to cause the conveyor motor 244 to advance the conveyor belt 241 incrementally to allow for deposition of a single row of sol-gel precursor solution droplets 18 onto the print surface 243 of the conveyor belt 241, before advancing the conveyor belt 241 to present an empty print surface 243 under the dispensing unit 220 to allow for deposition of the next row of sol-gel precursor solution droplets 18 onto the print surface 243.

As described before, in at least some embodiments, a continuous sol-gel particle production system 200 may include several dispensing units 220 mounted to a transport unit 211 and positionable therewith, in which case, the precursor solution transfer unit 224 may be configured to transfer precise preselected amounts of sol-gel precursor solution from the precursor solution reservoir 222 to each of the dispensing units 220 through supply conduits 221 interconnected thereinbetween. The sol-gel precursor solution may be transferred by the precursor solution transfer unit 224 to different microchannel tubes to enable dispensing multiple sol-gel precursor solution droplets 18 onto the print surface 243 at a time, once again, wherein each of the sol-gel precursor solution droplets 18 have a precise preselected volume. The microchannel tubes may be dimensioned and configured to dispense a consistent preselected volume of the sol-gel precursor solution therethrough. Thus, the sol-gel precursor solution droplets 18 may be dispensed onto a print surface 243 each having a precise preselected volume by the microchannel pipettes at rates of dozens or more sol-gel precursor solution droplets 18 at a time.

With reference once again to FIG. 7, the continuous sol-gel particle production system 200 includes a heat source, such as heating unit 246, to facilitates drying (e.g., removal of solvents) of the sol-gel precursor solution droplets 18 dispensed onto a print surface 243. The heating unit 246 may apply heat to the sol-gel precursor solution droplets 18 dispensed onto the print surface 243 as the conveyor belt 241 is moved rearward from the transport assembly 210, such as is shown by way of example only in FIG. 7. The heating unit 246 is dimensioned and configured to generate sufficient heat to dry the sol-gel precursor solution droplets 18 in the timeframe in which the sol-gel precursor solution droplets 18 are passing through the heating unit 246. As will be appreciated, the amount of heat generated by the heating unit 246 is dependent on a number of factors including, but not limited to, the volume and composition of the sol-gel precursor solution droplets 18 and the transport speed of the conveyor belt 241 through the heating unit 246. As represented diagrammatically in FIG. 7, a portion of the conveyor belt 241 enters the heating unit 246 with the sol-gel precursor solution droplets 18 disposed on the print surface 243 thereof, and exits the heating unit 246 with the fully formed sol-gel particles 10 disposed thereon.

The continuous sol-gel particle production system 200 in accordance with at least some embodiments of the disclosure includes a collection unit 248 disposed adjacent the rearward end of the conveyor belt 241 of the conveyor assembly 240. As shown in FIG. 7, in at least some embodiments, the collection unit 248 comprises a trough like configuration, such that the sol-gel particles 10 may simply roll off of the end of the conveyor belt 241, as it moves around rearward roller 245, and fall by gravity into the collection unit 248. As further shown in FIG. 7, a storage container 249 is disposed in communication with the collection unit 248. The storage container 249 is dimensioned and configured to receive the sol-gel particles 10 therein where they may be readied for storage or transport to an end user.

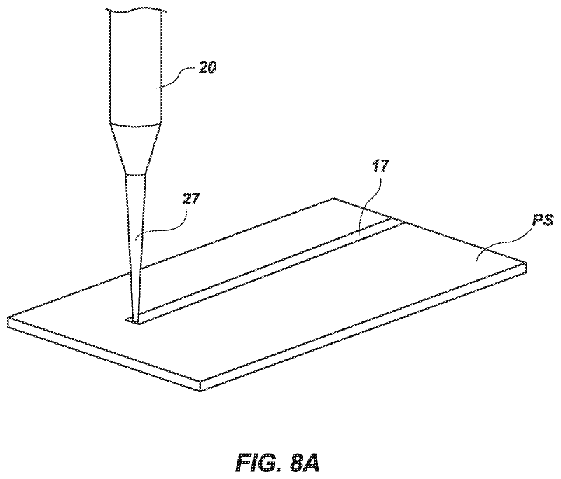

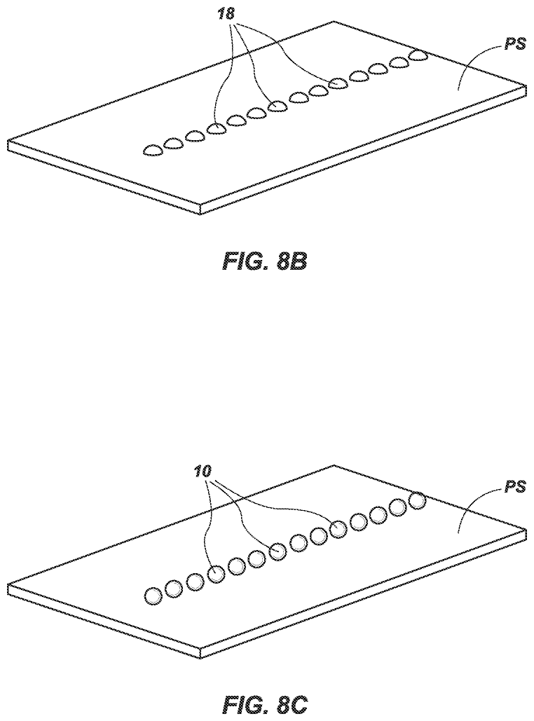

Looking next to FIGS. 8A through 8C, presented therein are diagrammatic representations of the formation of sol-gel particles 10 comprising one or more homogenously distributed dopants from a continuous linear deposition of a sol-gel precursor solution 17, in accordance with one or more embodiments of the disclosure. As shown best in FIG. 8A, in at least one embodiment of the disclosure, instead of dispensing individual sol-gel precursor solution droplets 18 from a dispensing unit 20 onto a print surface PS as disclosed and described above with reference to the batch and continuous sol-gel particle production systems 100, 200, respectively, a single continuous line of sol-gel precursor solution 17 is dispensed onto a print surface PS via a pipette tip 27 of a dispensing unit 20. As will be appreciated, a single continuous line of sol-gel precursor solution 17 may be dispensed onto a print surface 132 via a dispensing unit 120 of a batch sol-gel particle production systems 100 or a onto a print surface 243 of a continuous sol-gel particle production systems 200 via a dispensing unit 220.

With reference next to FIG. 8B, a period of time after dispensing a single continuous line of sol-gel precursor solution onto a print surface PS, the sol-gel precursor solution begins to coalesce into sol-gel precursor solution droplets 18 disposed substantially in a line along the path of the single continuous line of sol-gel precursor solution. The period of time to coalesce the sol-gel precursor solution may be dependent on a number of factors including, but not limited to, the composition of the sol-gel precursor solution, the surface tension and viscosity of the sol-gel precursor solution, the width and depth of the continuous line of sol-gel precursor solution, and the temperature and humidity of the air surrounding the continuous line of sol-gel precursor solution on the print surface.

With reference to FIG. 8C, after a further period of time, the sol-gel precursor solution droplets dry sufficiently to form sol-gel particles 10. The further period of time to dry the sol-gel precursor solution droplets 18 may be dependent on a number of factors including, but not limited to, the composition of the sol-gel precursor solution, the volume of the sol-gel precursor solution droplets, and the temperature and humidity of the air surrounding the sol-gel precursor solution droplets on the print surface.

This disclosure further contemplates one or more methods of producing sol-gel particles including one or more dopants. For instance, a method for producing sol-gel particles comprising one or more dopants includes preparing a sol-gel precursor solution. As disclosed hereinabove, a sol-gel precursor solution may include a sol-gel precursor, an acid, at least one solvent, and one or more dopants. In some embodiments, a sol-gel precursor solution may include an organic solvent and/or an aqueous solvent. The potential sol-gel precursors, acids, solvents, and dopants, as well as relative amounts of each which may be incorporated into a sol-gel precursor solution are disclosed in detail hereinabove.

The method for producing sol-gel particles including one or more dopants also includes dispensing droplets of the sol-gel precursor solution onto a print surface. The print surface in one or more embodiments comprises a hydrophobic print surface. In some embodiments, the method includes dispensing the sol-gel precursor solution droplets each having a precise preselected volume onto a print surface. As previously disclosed, various properties of the sol-gel precursor solution (e.g., composition, dopant concentration, surface tension, viscosity, etc.) combined with the hydrophobicity of the print surface may be modified so as to produce sol-gel particles having a desired shape and/or particle size, i.e., effective diameter. The volume of the sol-gel precursor solution droplets, the concentration of the sol-gel precursor in the sol-gel precursor solution, and annealing temperatures may be varied to impact the size of the sol-gel particles formed in accordance with the methods of the disclosure.

As disclosed hereinabove, dispensing the sol-gel precursor solution droplets each having a precise preselected volume onto a print surface in accordance with the method may be accomplished manually, or by way of a dispensing unit of a batch or continuous sol-gel particle production system as disclosed in detail above. Alternatively, the method may include dispensing a single continuous line of sol-gel precursor solution onto a print surface.

The method for producing sol-gel particles including one or more dopants further comprises drying the sol-gel precursor solution droplets dispensed onto the print surface. Drying the sol-gel precursor solution droplets in one or more embodiments includes removing at least a portion of the at least one solvent from the sol-gel precursor solution on the print surface, thereby forming sol-gel particles including the at least one dopant substantially homogeneously dispersed throughout. In some embodiments, the sol-gel precursor solution droplets are permitted to dry over time under ambient conditions, a process which may take days to fully accomplish. In at least some embodiments, the method employs a heat source or a heating unit to facilitate and expedite the drying process. In at least some embodiment, employing a heat source or heating unit decreases the drying time of the sol-gel precursor solution droplets from days to hours, and in some further embodiments, from days to minutes.

The method for producing sol-gel particles including one or more dopants in accordance with some embodiments of the disclosure includes the additional act of annealing the sol-gel particles. Annealing involves heating the sol-gel particles to an elevated temperature, such as, by way of example, to a temperature of from about 300° Celsius to about 700° Celsius, or more, for a predetermined period of time. As previously disclosed, annealing may also impact the particle size, i.e., the effective diameter, of the final sol-gel particles produced.

The method for producing sol-gel particles including one or more dopants in accordance with some embodiment of the disclosure also includes packaging the sol-gel particles into one or more storage containers. The sol-gel particles may be packaged into one or more storage containers as warranted for storage and/or transport to an end user.

The advanced manufacturing systems and methods described and disclosed hereinabove in accordance with embodiments of the disclosure may be utilized to produce from gram to kilogram quantities of sol-gel particles including one or more dopants homogeneously dispersed throughout on a daily basis, which would significantly reduce the cost of producing sol-gel particles. Use of the advanced manufacturing systems and methods according to embodiments of the disclosure may also reduce personnel exposure to radionuclides during the process of soil-gel particle production, by way of the batch and continuous soil-gel particle production systems disclosed herein. The production of sol-gel particles in accordance with one or more embodiments of the disclosure is robust, and in some embodiments, the sol-gel particles may be produced autonomously and, as warranted, within a radiological hot cell or glovebox environment, or a remote radioactive or automated clean room environment. The production of sol-gel particles according to embodiments of the disclosure may be used to form sol-gel particles comprising one or more dopants in quantitatively determinable amounts, without chemical fractionation.

The invention is further defined by reference to the following examples, which describe in further detail the preparation of sol-gel particles in accordance with embodiments of the disclosure. It will be apparent to those skilled in the art that many modifications, both to materials and methods, may be practiced without departing from the scope of the disclosure.

### EXAMPLES

### Example 1

### Sol-Gel Particle Size and Mass

Sol-gel precursor solutions were prepared by combining TEOS, ethanol and a 3 M nitric acid solution in a ratio of 1.6:1:10 v/v, respectively, in appropriately sized containers, typically, a 50 mL centrifuge tube. The solutions were mixed until homogenized, and poured into a 150 mL multichannel pipette reservoir.

A 96 channel pipette was used to dispense sol-gel precursor solution droplets of different preselected volumes onto a plate having a BYTAC® polytetrafluoroethylene coated deposition surface. The dispensed sol-gel precursor solution droplets were allowed to dry for a minimum of four (4) hours in a glove bag. The 4 hour gelation time was selected as it was observed to be the minimum amount of time for the particles to gel and obtain a hardness sufficient to be removed from the deposition surface.

Several factors were found to impact the particle size of the sol-gel particles, including the volume of the sol-gel precursor solution droplets dispensed onto the deposition surface, as well as subsequent annealing of the sol-gel particles.

Sol-Gel Precursor Solution Droplet Volume

Table 1 below demonstrates a correlation between the volume of sol-gel precursor solution droplets dispensed and the particle size of the sol-gel particles formed.

TABLE 1
Dispensed Volume of Sol-Gel Precursor
Solution and Sol-Gel Particle Size

| Droplet | Particle | Variation |
|---|---|---|
| Volume (μL) | Size (mm) | (±1σ, mm) |
| 1 | 0.522 | 0.0332 |
| 2 | 0.658 | 0.0415 |
| 4 | 0.874 | 0.0686 |
| 6 | 0.930 | 0.0726 |
| 8 | 1.140 | 0.0727 |
| 10 | 1.387 | 0.0611 |

As may be seen from Table 1, the measured sol-gel particle sizes ranged from about 0.522 mm to about 1.4 mm for 1 uL to 10 uL volume droplets, respectively, after being dried for 4 hours. The trend in particle size with droplet volume was found to be highly linear.

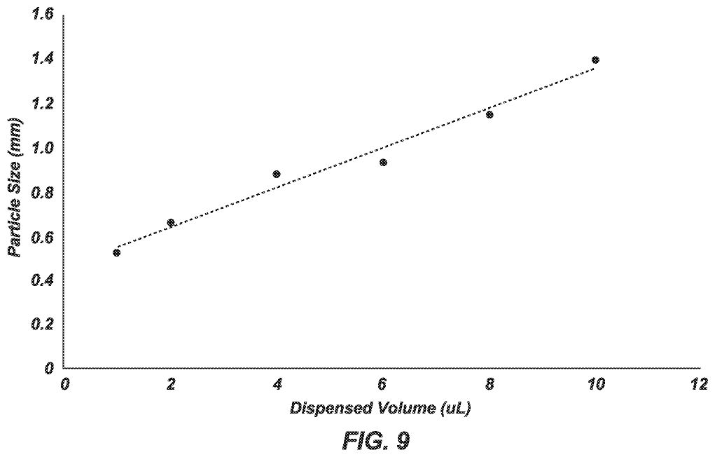

FIG. 9 presents a graphical representation of the sol-gel particle size as a function of dispensed volume of sol-gel precursor solution droplet data of Table 1. As is apparent from FIG. 9, as the volume of the sol-gel precursor solution dispensed was increased, the particle size of the sol-gel particles formed therefrom also increased. Conversely, as the volume of the sol-gel precursor solution dispensed was decreased, the particle size of the sol-gel particles formed therefrom also decreased.

Annealing Temperature

Heating dispensed sol-gel precursor solution droplets promoted continued drying and polymerization of the gelled material by driving off retained water, ethanol, and alkoxyl groups. Annealing at higher temperatures promoted faster drying and polymerization. Sol-gel particles formed from 6 μL droplets of the sol-gel precursor solution were annealed for one hour in a muffle furnace at various temperatures, and the change in particle size with annealing temperature was measured.

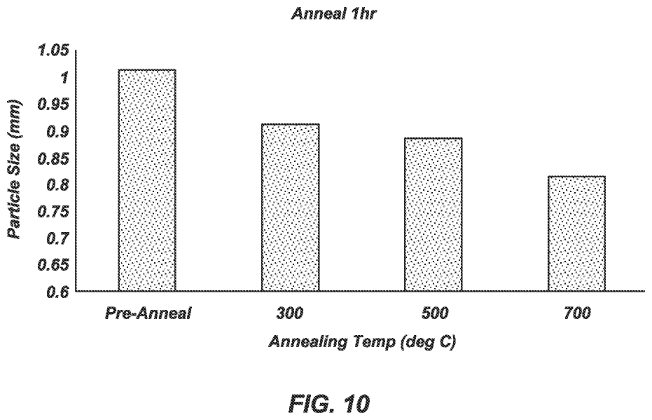

FIG. 10 is a graphical representation of the particle sizes of sol-gel particles after they were annealed in a muffle furnace for about one hour at different annealing temperatures (measured in degrees Celsius). As may be seen from FIG. 10, the particle size of the sol-gel particles decreased as the annealing temperatures increased. Specifically, a nearly 20% decrease in particle size was observed after the sol-gel particles were annealed for one hour at 700 degrees Celsius, as shown in FIG. 10.

Sol-Gel Precursor Concentration

A number of sol-gel precursor solutions were prepared having different concentrations of TEOS ranging from about 2 percent by volume to about 13 percent by volume in the sol-gel precursor solution. The sol-gel precursor solutions were dispensed to form sol-gel precursor solution droplets having a volume of about 1 μL each.

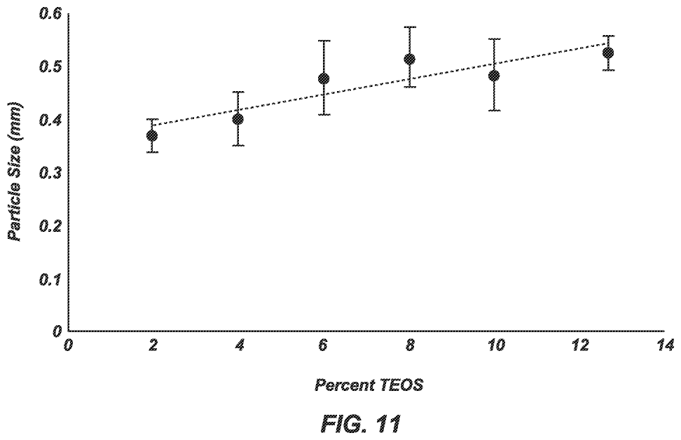

FIG. 11 is a graphical representation of the size of the sol-gel particles formed from the 1 μL droplets of a sol-gel precursor solution as a function of the percentage of the sol-gel precursor solution. As may be seen form FIG. 11, as the percentage of TEOS in the sol-gel precursor solution decreased, the particle size of the sol-gel particles formed therefrom decreased, and as the percentage of TEOS in the sol-gel precursor solution increased, the particle size of the sol-gel particles formed therefrom increased. Specifically, as the percentage of TEOS in the sol-gel precursor solution decreased from about 13% to about 2%, the particle size of the sol-gel particles formed therefrom decreased by about 30%, as shown in FIG. 11.

Sol-Gel Particle Mass

Sol-gel precursor solutions were prepared as described above with regard to droplet volume and annealing temperature, and sol-gel particles were formed from sol-gel precursor solution droplets at different dispensed droplet volumes. The masses of the sol-gel particles formed were initially measured immediately after being dried for 4 hours, and the masses of the sol-gel particles were measured again after up to 10 days of continued drying.

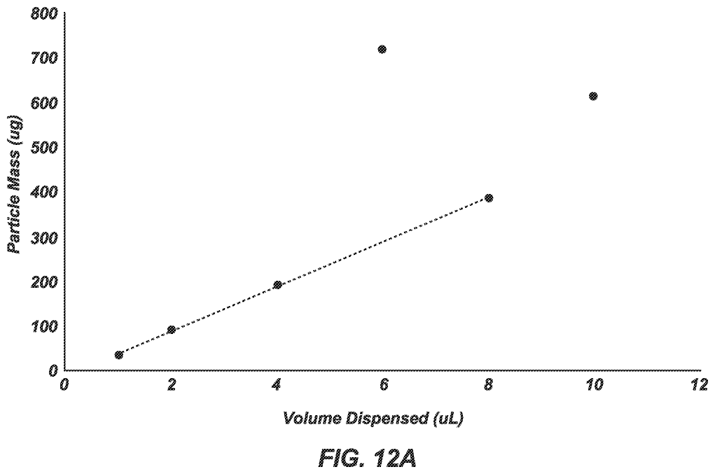

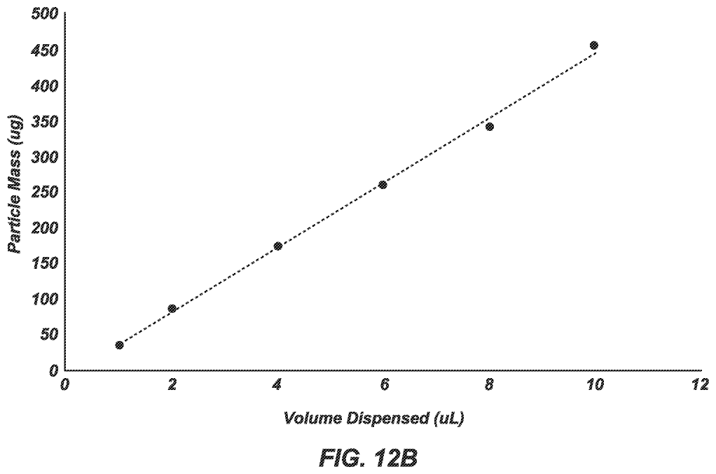

FIG. 12A is a graphical representation of sol-gel particle mass as a function of volume of the dispensed sol-gel precursor solution droplets after 4 hours of drying time. FIG. 12B is a graphical representation of sol-gel particle mass as a function of volume of the dispensed sol-gel precursor solution droplets after 8 to 10 days of continued drying. Although some anomalies were observed, specifically, with regard to droplet volumes of 6 μL and 10 μL which, as may be seen from FIG. 12A, produced particles of greater mass than expected, the mass of the sol-gel particles decreased with continuous drying regardless of the volume of dispensed sol-gel precursor solution droplets, as may be seen from a comparison of FIG. 12B with FIG. 12A.

### Example 2

### Chrome and FerroChrome Sol-Gel Particles

### Chrome Sol-Gel Particles

Sol-gel particles with chrome were prepared by incorporating chromium oxide, which was dissolved and heated in nitric acid and then dissolved and heated in hydrochloric acid, or a chromium III chloride hexahydrate solution into a sol-gel precursor solution.

The sol-gel precursor solution (Sol) was formed by combining TEOS, ethanol and water in a ratio of about 3.1 mL TEOS:2.3 mL EtOH:4.6 mL H₂O. The dissolved chromium oxide or chromium III chloride hexahydrate solution was added to the Sol in amounts of at least 2 mg Cr₂O₃/mL Sol or CrCl₃ equivalent. The volume of chromium solution added to the Sol replaced a portion of the volume of water in the Sol. For example, for each 1 mL of chromium solution added, 1 mL of water was subtracted from the Sol. To form sol-gel particles of a darker color, additional chromium solution was added to the Sol.

The dilution factors presented in the table below were used to determine an appropriate amount of analyte and additional volumes to be added to the Sol. Approximately 0.5 grams of sol-gel particles were formed from about 6 mL of uncolored Sol. The diluted Sol was allowed to react for approximately 30 minutes, to allow the Sol to homogenize. The Sol was transferred to a dispensing vessel and the Sol was pipetted onto a drying surface to from sol-gel particles with chrome.

### Dilution Factors

| Mean | Dilution | Approx. | Pipetting |
|---|---|---|---|
| Particle Size | Factor | Volume for 1 g | amount |
| <500 μm | At least 4x | 48 mL | 1 μL |
| 500-750 μm | 3x-6x | 36 mL-72 mL | 2.5 μL-5 μL |
| >1000 μm | 1.33x-2x | 16 mL-24 mL | 10 μL-20 μL |

### FerroChrome Sol-Gel Particles

Gel-sol particles with iron and chrome were prepared by incorporating chromium oxide, which was dissolved and heated in nitric acid and then dissolved and heated in hydrochloric acid, or a chromium III chloride hexahydrate solution into a sol-gel precursor solution, after which, a solution of either iron II chloride or iron III chloride was added. Iron II chloride was prepared by dissolving iron filings in concentrated HCl. Other iron solutions were prepared in various ways, for example, iron solutions were prepared by dissolving other water-soluble or acid-soluble iron compounds.

The sol-gel precursor solution (Sol) was formed by combining TEOS, ethanol and water in a ratio of about 3.1 mL TEOS:2.3 mL EtOH:4.6 mL H₂O. The dissolved chromium oxide or chromium III chloride hexahydrate solution was added to the Sol in amounts of at least 2 mg Cr₂O₃/mL Sol or CrCl₃ equivalent. The volume of chromium solution added to the Sol replaced a portion of the volume of water in the Sol. For example, for each 1 mL of chrome solution added, 1 mL of water was subtracted from the Sol.

The iron II chloride or iron II chloride solution was added to the Sol in amounts of between about 1 to 5 percent iron content. Iron II chloride imparted a yellow-green color to the sol-gel particles, while iron III chloride imparted an orange-yellow to brown color. To form brown colored sol-gel particles, the iron II chloride or iron II chloride solution was added in amount of between about 3 to 5 percent iron content. The sol-gel fractured more frequently at higher iron contents.

The dilution factors presented in the table below were used to determine the appropriate amount of analyte and additional volumes to be added to the Sol. Approximately 0.5 grams of sol-gel particles were formed from about 6 mL of uncolored Sol. The diluted Sol was allowed to react for approximately 30 minutes, to allow the Sol to homogenize. The Sol was transferred to a dispensing vessel and the Sol was pipetted onto a drying surface to from sol-gel particles with iron and chrome.

### Dilution Factors

| Mean | Dilution | Approx. Volume | Pipetting |
|---|---|---|---|
| Particle Size | Factor | for 1 g | amount |
| <500 μm | At least 4x | 48 mL | 1 μL |
| 500-750 μm | 3x-6x | 36 mL-72 mL | 2.5 μL-5 μL |
| >1000 μm | 1.33x-2x | 16 mL-24 mL | 10 μL-20 μL |

### Example 3

### Glove Bag Methods for Producing Sol-Gel Particles

Complete Glove Bag Method with Heated Drying

The equipment and materials utilized included a hotplate with insulating tile; a microwell plate (if a 12 channel pipette was used); a pipette or multichannel pipette and associated pipette tips; a BYTAC® deposition surface; crucibles; one or more collection vials; tetraethyl orthosilicate (TEOS); ethanol; 18 MΩ water; a radioactive FP mixture; a scrapper or spatula with flat edge preferred; and a transfer pipette.

A glove bag was appropriately vented and weighted to provide a flat work surface. The equipment and materials were loaded into the glove bag, and arranged for use. A solution was prepared from an amount of about 3.4 mL TEOS and an amount of about 2 mL ethanol; i.e., in a ratio of about 3.4:2 by volume. About 3.4 ml TEOS created about 1 gram of sol-gel particles. An ascorbic acid solution was prepared from about 0.1 g/ml ascorbic acid in water. The TEOS-EtOH solution, the ascorbic acid solution, and an additional amount of water were placed into the glove bag. A radioactive FP mixture was prepared and placed into the glove bag and diluted to 30 mL. About 4.6 ml of the ascorbic acid solution and the TEOS-EtOH solution were added to the radioactive FP solution, and the combined solution was capped and contacted until the combined solution was homogenous. If a multichannel pipette was used, the combined solution was transferred into the microwell plate. Droplets of the combined solution were dispensed onto the BYTAC® deposition surface. Droplets of the combined solution having volumes of about 9 μl were dispensed to form sol-gel particles of about 950 inn, and droplets of the combined solution having volumes of about 1 μl were dispensed to form sol-gel particles of about 500-600 μm.

The hotplate was preheated to about 85° C. Once the dispensed droplets reached a firm gel state, the formed sol-gel particles were scraped into crucibles, ensuring the particles were dispersed to prevent aggregates. The crucibles were placed onto the hotplate and the sol-gel particles were dried until a hard gel was formed, which was typically indicated by a milky yellow coloration and significant size reduction. Any aggregates observed were broken up, and the sol-gel particles were poured into one or more of the collection vials. The collection vials were closed and removed from the glove bag, and transferred to a fume hood. The sol-gel particles were annealed to about 300° C. for 30 minutes, at a 10° C./min ramp rate, under the fume hood. The resultant sol-gel particles were black in color, with about 1 gram of sol-gel particles produced.

Partial Glove Bag Processing Method with Heated Drying

The equipment and materials utilized included a microwell plate (if a 12 channel pipette was used); a pipette or multichannel pipette and associated pipette tips; a BYTAC® deposition surface; crucibles; tetraethyl orthosilicate (TEOS); ethanol; 18 MΩ water; a radioactive FP mixture; a scrapper or spatula with flat edge preferred; a transfer pipette; and transfer bags.

A glove bag was appropriately vented and weighted to provide a flat work surface. The equipment and materials were loaded into the glove bag, and arranged for use. A solution was prepared from an amount of about 3.4 mL TEOS and an amount of about 2 mL ethanol; i.e., in a ratio of about 3.4:2 by volume. About 3.4 ml TEOS created about 1 gram of sol-gel particles. An ascorbic acid solution was prepared from about 0.1 g/ml ascorbic acid in water. The TEOS-EtOH solution, the ascorbic acid solution, and an additional amount of water were placed into the glove bag. A radioactive FP mixture was prepared and placed into the glove bag and diluted to 30 mL. About 4.6 ml of the ascorbic acid solution and the TEOS-EtOH solution were added to the radioactive FP solution, and the combined solution was capped and contacted until the combined solution was homogenous. If a multichannel pipette was used, the combined solution was transferred into the microwell plate. Droplets of the combined solution were dispensed onto the BYTAC® deposition surface. Droplets of the combined solution having volumes of about 9 μl were dispensed to form sol-gel particles of about 950 inn, and droplets of the combined solution having volumes of about 1 μl were dispensed to form sol-gel particles of about 500-600 μm.

Once the dispensed droplets reached a firm gel state, the formed sol-gel particles were scraped into crucibles, ensuring the particles were dispersed to prevent aggregates. The crucibles were placed into one or more of the transfer bags, and transferred to a fume hood where the sol-gel particles were dried at about 85° C. until the sol-gel particles were a milky yellow or light blue. Any aggregates observed were broken up. The sol-gel particles were annealed to about 300° C. for 30 minutes, at a 10° C./min ramp rate, under the fume hood. The resultant sol-gel particles were black in color, with about 1 gram of sol-gel particles produced.

Complete Bag Processing Method without Heated Drying

The equipment and materials utilized included a microwell plate (if a 12 channel pipette was used); a pipette or multichannel pipette and associated pipette tips; a BYTAC® deposition surface; crucibles; tetraethyl orthosilicate (TEOS); ethanol; 18 MΩ water; a radioactive FP mixture; a scrapper or spatula with flat edge preferred; and a transfer pipette.

A glove bag was appropriately vented and weighted to provide a flat work surface. The equipment and materials were loaded into the glove bag, and arranged for use. A solution was prepared from an amount of about 3.4 mL TEOS and an amount of about 2 mL ethanol; i.e., in a ratio of about 3.4:2 by volume. About 3.4 ml TEOS created about 1 gram of sol-gel particles. An ascorbic acid solution was prepared from about 0.1 g/ml ascorbic acid in water. The TEOS-EtOH solution, the ascorbic acid solution, and an additional amount of water were placed into the glove bag. A radioactive FP mixture was prepared and placed into the glove bag and diluted to 30 mL. About 4.6 ml of the ascorbic acid solution and the TEOS-EtOH solution were added to the radioactive FP solution, and the combined solution was capped and contacted until the combined solution was homogenous. If a multichannel pipette was used, the combined solution was transferred into the microwell plate. Droplets of the combined solution were dispensed onto the BYTAC® deposition surface. Droplets of the combined solution having volumes of about 9 μl were dispensed to form sol-gel particles of about 950 inn, and droplets of the combined solution having volumes of about 1 μl were dispensed to form sol-gel particles of about 500-600 μm.

The dispensed droplets were allowed to dry to a hard gel state, and the formed sol-gel particles were scraped into the crucibles, ensuring the particles were dispersed to prevent aggregates. The crucibles were placed into the transfer bag, and transferred to a fume hood. The sol-gel particles were annealed to about 300° C. for 30 minutes, at a 10° C./min ramp rate, under the fume hood. The resultant sol-gel particles were black in color, with about 1 gram of sol-gel particles produced.

### Example 4

### Surrogate Nuclear Debris Soil Matrix Samples

Production of Surrogate Nuclear Debris Soil Matrix Blanks

Surrogate nuclear debris soil matrix blanks (i.e., non-radioisotope containing) were produced with an elemental matrix composition targeted at approximating that of major soil constituents such as aluminum, iron, calcium, sodium and silica. The surrogate nuclear debris soil matrix blanks were produced via a sol-gel drop cast method, where a silica matrix was synthesized from silicate precursors and polymeric hydrolysis/condensation reactions. Tetraethyl ortho silicate was combined with ethanol and 3 M hydrochloric acid to from the sol-gel precursor solution. The sol-gel precursor solution was combined with amounts of aluminum nitrate, iron nitrate, calcium nitrate, and sodium nitrate to produce a sol-gel precursor solution having a weight percent of each element as shown in the table below.

| Element | Wt % |
|---|---|
| Al | 8.1 |
| Fe | 5.0 |
| Ca | 3.6 |
| Na | 2.8 |

This composition is similar to plagioclase and alkali feldspar, one of the major components of the earth's crust. The sol-gel precursor solution was drop cast onto TEFLON® coated plates. Approximately 24 plates which each contained about 1152 droplet depositions were cast and dried in a fume hood for 24 hrs. The resultant dried particles were collected and annealed in an oven at 500° Celsius for about one hour during which a color change occurred as iron nitrate was converted to iron oxide which produced a reddish-brown color.

Approximately 0.4 grams of the surrogate nuclear debris soil matrix blanks were collected. The particles were examined via optical microscopy. Particles had an average size of 436±56 microns with a maximum size of 620 microns and a minimum size of 280 microns. Surrogate nuclear debris soil matrix blanks were also analyzed by scanning electron microscopy and energy dispersive X-ray spectroscopy for elemental analysis (EDS). The EDS analysis showed a mostly uniform distribution of all the relevant elements across the whole particle, with a weight percent that closely matched the targeted weight percent in the sample production, as shown in the table below.

| Element | Target Wt % | Measured Wt % | Soil Wt %¹ |
|---|---|---|---|
| Al | 6.69 | 6.46 | 8.12 |
| Fe | 4.47 | 7.39 | 5.00 |
| Ca | 2.82 | 2.9 | 3.63 |
| Na | 5.42 | 6.18 | 2.83 |
| Si | — | 18.36 | 27.72 |
| O | — | 58.72 | 46.6 |

Target weight percentages were calculated only for Al, Fe, Ca and Na with the Si and O components presumed to come mostly from the SiO₂ matrix.

Metal Loading of Sol-Gel Particles for Surrogate Nuclear Debris

The materials and equipment utilized included tetraethyl orthosilicate, 98%, obtained from ACROS Organics; ethyl alcohol, pure (i.e., 200 proof HPLC grade), aluminum nitrate nonahydrate (98%, ACS reagent grade), iron (III) nitrate nonahydrate (98%, ACS reagent grade), calcium nitrate tetrahydrate (99%, ACS reagent grade), calcium chloride dihydrate (crystals, ACS grade), and sodium chloride (molecular biology grade) obtained from Sigma Aldrich; nitric acid (optima grade) and sodium nitrate (certified ACS crystal) obtained from ThermoFisher Scientific; and iron (III) chloride hexahydrate (97-102%, ACS grade) obtained from Alfa Aesar. A JCM-7000 Benchtop SEM was used for SEM and EDS analysis. The sol-gel particles formed were adhered onto carbon tape for SEM/EDS analysis. The average particle size of the sol-gel particles formed was determined using a ZEISS SteREO Discovery.V12 microscope.

The sol-gel particles were synthesized using an acid catalyzed sol-gel process. An amount of 3.2 ml of tetraethyl orthosilicate (TEOS) and 3.0 ml of ethanol were combined and then added to 20 ml of 3 M nitric acid. The solution was shaken for about 2 minutes. Droplets of about 10 μl each (192 per solution prepared) of the sol-gel precursor solution were pipetted onto BYTAC® sheets and air dried for a minimum of 18 hours before being collected for analysis. For metal doped particles, nitrate salts were dissolved in the 3 M nitric acid before mixing in with the TEOS and ethanol. Nitrate salts were added in quantities relative to the number of mols of silica present and are represented as a percentage of total mol percent (mol metal/(mol metal+mol silica)). Sodium, calcium, aluminum, and iron were added individually from 2.5-80% mol metal. Additionally, sodium and calcium were combined at varying concentrations in sol-gel particles, and all four elements were combined as well. These percentages represent the total metal mol percent, with each of the metals present in equal molar amounts. Sol-gel particles were also synthesized using chloride salts as the metal precursor instead of nitrate salts to investigate how the source of the metal affected the loading capacity. The particles formed from chloride salts were synthesized with the same method as with the nitrate salts above.

The sol-gel particles with no metal added were hemispherical and translucent. SEM analysis showed the surfaces were smooth, and EDS showed a homogenous distribution of Si and O throughout the particles. Of note, EDS analysis did not detect nitrogen from the nitric acid.

Sol-gel particles with low amounts of sodium were also smooth and translucent. Microscope images showed the particles became less and less translucent as the sodium content increased, until at 40 metal mol % sodium, the particles were a solid white. SEM analysis also showed that as the sodium content increased, rough features appeared on the surface. More outcroppings were present as the sodium concentration increased, and at higher concentrations, the entire surfaces of the particles were rough as the outcroppings completely covered the smooth surfaces. EDS analysis showed that these outcroppings were concentrated in sodium and nitrogen, with little to no silica present. The smooth interior still contained some sodium, but in much lower concentrations than the outcroppings. The outcroppings took different shapes, some being thin string-like configurations and others being small round bumps, but regardless of the shape the outcroppings were found to be concentrated in sodium nitrate and low in silica. This trend was consistent for all other metal nitrate salts used.

Calcium doped sol-gel particles showed similar trends as sodium but were slightly more translucent at 40 metal mol %. Again, as the metal concentration was increased, the formation of outcroppings was more prevalent. Of note, the calcium sol-gel particles at higher concentrations were much less hemispherical as the outcroppings were much larger and grown away from the smooth surface, rather than maintaining its shape. The outcroppings were also higher in metal nitrate concentration.

Aluminum doped sol-gel particles also showed similar trends to sodium and calcium particles, but of note was their much larger size. Additionally, at 80 mol metal % the synthesis with aluminum was unsuccessful as the sol-gel precursor solution did not dry as a particle, but rather fell apart into small pieces. Like calcium, the outcroppings observed with aluminum at intermediate concentrations (i.e., 20 mol metal % and 40 mol metal %) tended to be larger and grown away from the smooth surface. Notably different, was that as the concentration was increased, the particles again took on a hemispherical shape, with a rough surface that more closely resembled what was observed with sodium.

The color change in iron doped sol-gel particles was more noticeable at lower concentrations, starting as a light yellow which turned into orange and got darker as the concentration was increased. Notably, at higher iron concentrations (e.g., 60 mol metal % and 80 mol metal %) there were parts of the particle surfaces that were all white. Like aluminum, at 80 mol metal % iron, synthesis did not form particles, but dried into small pieces.

Generally, as more nitrate salt was added the sol-gel particle size increased. This was a measure of how much the droplets spread out (i.e., the diameter of the flat, bottom side). Of note, the trend was not always linear, as some sodium doped sol-gel particles experienced a brief decrease in size. Additionally, the size of the sol-gel particles generally followed the trend that metals with larger atomic radii led to larger droplets. This was not likely the only factor that determined particle size, for instance, the larger metals were also likely to have been accompanied by more nitrate counter ions. The yield of the synthesis as a function of the mass of the metal added was found to be more related to the number of counter ions, and the relative contribution of the metal to the entire nitrate salt's molecular weight.

Sodium and calcium were doped together in some sol-gel particles. These particles showed a similar trend in color, as particles higher in metal were not transparent and a dark white. Additionally, outcroppings were observed as in the sol-gel particles doped with a single element. Interestingly, the outcroppings were found to be concentrated in either sodium or calcium, but not both elements. While outcroppings were observed for both elements, a higher portion of sodium was found in the outcroppings, while calcium was found in the highest concentrations in the outcroppings but was still observed throughout the particle in appreciable amounts.

When Na, Ca, Fe, and Al nitrate salts were all added together in the sol-gel particles, the color of particles appeared to be dictated by iron. Like the other sol-gel particles prepared, at higher metal concentrations rough features covered a smooth interior. Interestingly, EDS analysis showed that the smooth silica interior was predominately iron and calcium, while the rough surface features were predominately sodium and aluminum.

Like nitrate salt doped sol-gel particles, chloride salts were found distributed homogenously throughout the particles at low concentration, and outcroppings were formed at higher concentrations. The same trend of a core rich in silica with metal rich outcroppings was observed.

Metal doped sol-gel particles were exposed to water with different methods to investigate how the metal salts were incorporated into the structure. One method included dabbing particles with a water soaked Chemtech wipe and then immediately using a dry Chemtech wipe to remove excess water. This was intended to investigate how brief exposure to a small amount of water would affect the sol-gel particles. In the second method, sol-gel particles (<100 mg) were soaked in 50 ml of water for 3 hours. The water was decanted, and the particles were left to air dry overnight. The amount of water was in excess of what would be required to dissolve all the incorporated nitrate salts, and the soak duration was expected to be long enough for the water to work into the porous structure of the sol-gel particles.

Dabbing metal doped sol-gel particles with water was found to remove outcroppings from the surface. The silica rich interior remained seemingly unchanged based on SEM and EDS analysis. When particles were soaked in water, more extreme differences were observed. The metal content in particles with an initial metal content >50 mol metal % was drastically reduced. The metal in some particles with initially lower mol metal % was completely removed, at least to the extent of being below the detection limit of EDS. Sol-gel particles doped with all four metals showed that sodium and calcium were more likely be removed from the particle than aluminum or iron. Additionally, no appreciable amounts of nitrogen were detected in any of the soaked sol-gel particles.

Air dried metal doped sol-gel particles were annealed at 600° Celsius for 2 hours, with temperature ramping at 10° C./min. After 2 hours, the oven was turned off, and the particles were removed the following day.

Annealing sol-gel particles having low metal content had very little effect on their appearance observable by SEM or metal distribution by EDS analysis. At higher metal concentrations when outcroppings were present, annealing resulted in the particles losing some or all of the outcroppings. It does not appear that metal was lost from the particles after annealing, rather, it appeared that the metal was incorporated into the silica rich core. This was supported by images that showed the surface of particles changed from predominantly metal with little to no silica detectable before annealing, to a mixture of both after annealing. Nitrogen was found to be completely removed in all of the annealed sol-gel particles.

The acidic sol-gel mechanism began with the protonation of oxygen in the alkoxide group, which was then replaced via an SN₂ reaction with a water molecule (hydrolysis). As the reaction continued, hydrolyzed silica precursors began to condense into a gel-like structure. The gel-like structure was made up of many particles stuck together making a porous structure. The sol-gel did not become a solid structure until it was heated.

Due to their medical applications, there has been a significant amount of research done on calcium doped sol-gel particles with 70Si:30Ca, commonly called bioactive glass, including on how calcium is incorporated into the sol-gel matrix. Calcium nitrate was dissolved in the pore liquor during the gelation and ageing stage. As the poly-condensation reactions occurred, some of the pore liquor was expelled out of the gel and calcium nitrate along with it. This led to the formation of calcium nitrate deposits on the surface of the gel particles while drying. Additionally, other work showed calcium was incorporated into the sol-gel structure when the particles were heated to 400° Celsius or above, which also decomposed nitrate.

This proposed mechanism was supported by SEM and EDS analysis. Not only did calcium follow this trend, but the other elements did as well. Of note is that this movement of metal to the surface was more common at higher concentrations. This suggested that at lower concentrations, the metal ions were held in the porous structure of the sol-gel particles even when a portion of the pore liquor was expelled. Alternatively, the amount of metal expelled to the surface was insignificant compared to the amount of silica present. Additionally, combining metals in sol-gel particles revealed that individual metals behaved differently. For example, sodium and aluminum were more likely to be expelled from the pores and form outcroppings on the surface than calcium and iron. The annealing study also showed that the metals were incorporated into the sol-gel structure from the outcroppings as the nitrogen was lost. It should be noted that SIMS analysis showed that after incorporation of calcium by annealing, it was still found in higher concentrations near the surface.

Bioactive glass studies have also looked at how soaking particles in water and other solutions affect the sol-gel particles, as the purpose of bioactive glass is to leach silicon and calcium atoms in vivo to help promote bone regrowth. It was found that soaking bioactive glass particles in deionized water for as little as 0.5 hours was sufficient to remove nitrate ions. Unlike the present study, the bioactive glass particles were heated before soaking in deionized water. The removal of nitrogen was consistent with the present findings, but it was also observed that a substantial loss of metal occurred because the particles were not annealed beforehand. It is likely that annealing the particles before soaking would have resulted in less metal being removed as the metal ions would have been incorporated into the sol-gel structure.

Bioactive glass studies have also investigated methods to improve the incorporation of calcium into the sol-gel structure which may be applied to other metals as well. Annealing calcium nitrate particles above 400° Celsius was found to incorporate calcium into the sol-gel particle structure. The source of calcium was also found to influence how and if calcium was incorporated into the sol-gel particle structure. Calcium chloride was never found to be incorporated into the sol-gel particles regardless of annealing temperature, while the use of calcium methoxyethoxide and calcium hydroxide both resulted in calcium being incorporated into the sol-gel structure at room temperature. Alkoxides could be used as a source for other metals as well, like aluminum from aluminum isopropoxide, to prevent the production of surface outcroppings. Other studies investigated how the use of additional dopants improved the incorporation of metals into sol-gel structures. The addition of phosphoric acid (10 wt %) was found to prevent the precipitation of separate metal species and produced colorless films, suggesting the metals (Cr, Mn, Fe, Ni, or Cu) were incorporated into the sol-gel structure.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. Sol-gel particles comprising:
a reaction product of a sol-gel precursor, the reaction product comprising networked polymeric chains including silicon or a metal; and
at least one dopant substantially homogeneously dispersed in the reaction product of the sol-gel precursor.

2. The sol-gel particles of claim 1, wherein the sol-gel precursor comprises a silicon compound, a titanium compound, an aluminum compound, a germanium compound, a zirconium compound, a tin compound, or a combination thereof.

3. The sol-gel particles of claim 1, wherein the sol-gel precursor comprises tetramethyl orthosilicate or tetraethyl orthosilicate.

4. The sol-gel particles of claim 1, wherein the at least one dopant comprises at least one radionuclide.

5. The sol-gel particles of claim 1, wherein the at least one dopant comprises one or more of molybdenum, barium, strontium, zirconium, neodymium, cerium, aluminum, calcium, sodium, molybdenum, chrome, and iron or a compound thereof.

6. The sol-gel particles of claim 1, wherein the reaction product of the sol-gel precursor further comprises one or more of aluminum, calcium, sodium, molybdenum, chrome, and iron.

7. The sol-gel particles of claim 1, wherein the sol-gel particles exhibit an effective diameter of from about 0.01 millimeter to about 3.0 millimeters.

8. The sol-gel particles of claim 1, wherein the sol-gel particles exhibit a substantially spherical shape or a hemispherical shape.

9. A method of producing sol-gel particles, comprising:
forming a sol-gel precursor solution including at least one sol-gel precursor, at least one solvent, an acid, and at least one dopant;
dispensing the sol-gel precursor solution onto a print surface;
removing at least a portion of the at least one solvent from the sol-gel precursor solution on the print surface to form sol-gel particles including the at least one dopant substantially homogeneously dispersed throughout; and
removing the sol-gel particles from the print surface.

10. The method of claim 9, wherein forming a sol-gel precursor solution including the at least one sol-gel precursor, the at least one solvent, the acid, and the at least one dopant comprises combining a silicon-alkoxy monomer, water, nitric acid, and the at least one dopant to form the sol-gel precursor solution.

11. The method of claim 9, wherein dispensing the sol-gel precursor solution onto the print surface comprises dispensing droplets of the sol-gel precursor solution onto the print surface.

12. The method of claim 11, wherein dispensing droplets of the sol-gel precursor solution onto the print surface comprises dispensing the droplets of the sol-gel precursor solution onto a hydrophobic print surface.

13. The method of claim 9, wherein dispensing the sol-gel precursor solution onto the print surface comprises dispensing a substantially continuous line of the sol-gel precursor solution onto the print surface.

14. The method of claim 13, wherein removing the at least a portion of the at least one solvent from the sol-gel precursor solution on the print surface comprises removing the at least a portion of the at least one solvent from the substantially continuous line of the sol-gel precursor solution to form discrete droplets of the sol-gel precursor solution.

15. The method of claim 9, wherein removing the at least a portion of the at least one solvent from the sol-gel precursor solution on the print surface to form sol-gel particles comprises forming sol-gel particles exhibiting a contact angle with the print surface of from about 120 degrees to about 160 degrees.

16. The method of claim 9, wherein removing the at least a portion of the at least one solvent from the sol-gel precursor solution on the print surface to form sol-gel particles comprises forming the sol-gel particles by a batch process.

17. The method of claim 9, wherein removing the at least a portion of the at least one solvent from the sol-gel precursor solution on the print surface to form sol-gel particles comprises forming the sol-gel particles by a continuous process.

18. A system for producing sol-gel particles comprising:
a print surface;
a transport assembly having a transport unit positionable over and along the print surface;
a dispensing unit coupled to the transport unit and positionable therewith over and along the print surface, the dispensing unit configured to dispense a sol-gel precursor solution on the print surface;
a reservoir in fluid communication with the dispensing unit and configured to contain the sol-gel precursor solution;
a precursor solution transfer unit in fluid communication with the reservoir and the dispensing unit; and
a control unit in communication and operable with at least the transport assembly and the precursor solution transfer unit.

19. The system of claim 18, wherein the dispensing unit is configured to dispense a volume of the sol-gel precursor solution in a range of from about 1 nanoliter to about 25 microliters.

20. The system of claim 18, further comprising a heat source coupled to the print surface.
